(19) United States
(12) Patent Application Publication
(10) Pub. No.: US 2014/0081605 A1
(43) Pub. Date: Mar. 20, 2014

(54) DTM ESTIMATION METHOD, DTM ESTIMATION PROGRAM, DTM ESTIMATION DEVICE, AND METHOD FOR CREATING 3-DIMENSIONAL BUILDING MODEL, AND REGION EXTRACTION METHOD, REGION EXTRACTION PROGRAM, AND REGION EXTRACTION DEVICE

(71) Applicant: Junichi Susaki, Muko-shi (JP)

(72) Inventor: Junichi Susaki, Muko-shi (JP)

(73) Assignee: KYOTO UNIVERSITY, Kyoto-shi, Kyoto (JP)

(21) Appl. No.: 14/122,082

(22) PCT Filed: Apr. 26, 2012
(86) PCT No.: PCT/JP2012/061204

§ 371 Date: Nov. 25, 2013

(30) Foreign Application Priority Data
Jun. 9, 2011 (JP) 2011-129316
Jun. 29, 2011 (JP) 2011-144266

(51) Int. Cl. G06T 17/00; G06F 17/50

(52) U.S. Cl. CPC G06T 17/00; G06F 17/5004
USPC 703/1; 703/2

(57) ABSTRACT

In DTM estimation, no pixel data is present within a unit grid in a predetermined range linked to extract a river region. For data excluding the river region, a first maximum slope value is set and DTM is estimated. A local slope is calculated from the estimated DTM. If the slope exceeds value, a second maximum slope value greater than the first is set and DTM is estimated again. In region extraction, for extracting a building region based on a photograph, different discretization widths are set, and brightness values of data are discretized into values discretely set by each discretization widths. Pixels having identical value in a discretized image are linked, and a region having a rectangle shape is extracted as candidate of a building region. From the respective different discretization widths extracted, a region is employed, as a building region, in decreasing order of closeness shape to a rectangle.

### TECHNICAL FIELD

[DTM estimation method, DTM estimation program, DTM estimation device, and method for creating 3-dimensional building model]

The present invention relates to a technique of estimating a DTM (Digital Terrain Model) based on laser scanner data of an earth's surface obtained by an aircraft.

[Region extraction method, region extraction program, and region extraction device]

In addition, the present invention relates to a method, a program, and a device for extracting a region of a building based on data of a photograph taken from an aircraft or a satellite.

### BACKGROUND ART

[DTM estimation method, DTM estimation program, DTM estimation device, and method for creating 3-dimensional building model]

LiDAR (Light Detection And Ranging) data obtained as a reflected wave when an earth's surface is laser-scanned from an aircraft can be used as highly accurate point cloud data of 3-dimensional coordinates for measuring the height of a building or the tree height of a forest (for example, see PATENT LITERATURE 1). By this LiDAR data, for a desired region, a DSM (Digital Surface Model) including the uppermost portion of a building and the uppermost end of a tree as well as a ground surface (ground surface such as a site or a road) can be obtained.

On the other hand, by partially obtained data pieces of the ground surface and data pieces interpolated among said data pieces to obtain the entirety, a DTM representing only the ground surface can be estimated. Then, for example, the height of a building can be calculated as (DSM−DTM) (for example, see NON-PATENT LITERATURE 1). For estimating a DTM, the lowest elevation point in a predetermined range of LiDAR data is assumed to be a ground surface. Then, by searching for such a ground surface in said range and performing interpolation, a DTM can be estimated.

[Region extraction method, region extraction program, and region extraction device]

Feature extraction and region extraction in the case of viewing a city from above have been important themes for a long time (for example, NON-PATENT LITERATURE 1). For example, there have been many studies of road extraction from an aerial photograph or a satellite image (for example, NON-PATENT LITERATURES 3 and 4). Methods for classifying remotely sensed images can be roughly divided into pixel-based classification and region-based (object-based) classification. In the pixel-based classification method represented by clustering (so-called unsupervised), a maximum likelihood method (supervised), and Support Vector Machines (SVM) (supervised), based on a statistic theory, each pixel is assigned to a classification class (for example, NON-PATENT LITERATURE 5). On the other hand, in the region-based classification method, information (context) about the periphery of a pixel is used. Representative examples thereof include classifications using mathematical morphological approach and the like (for example, NON-PATENT LITERATURES 6 to 10).

In FIG. 22, (a) and (b) are examples of aerial photographs of an urban area (Higashiyama Ward, Kyoto City) where houses are densely located. In such a dense urban area, conventional region extraction methods do not work effectively. According to analysis of factors thereof the first factor is that (i) since buildings are close to each other, if the brightness values and the textures of roofs are similar, the boundary between the buildings becomes obscure. Secondly, there is a factor unique to a dense urban area that (ii) the shadow of an adjacent building often appears in a photograph. Further, since Japanese traditional buildings use roofs (for example, a slate root) having a wavelike cross-sectional shape, a factor due to building characteristics of a target area that (iii) it is difficult to extract the boundary of a roof having a texture with dispersion of the brightness value, can be also recognized.

### CITATION LIST

### Patent Literature

PATENT LITERATURE 1: Japanese Patent No. 4058293

### Non Patent Literature

NON PATENT LITERATURE 1: Susaki Junichi, Kora Atsushi, Kojima Toshiharu, “Construction of filtering algorithm for ground surface data in dense urban area from airborne LiDAR data”, Journal of Applied Survey Technology Vol. 21, pp. 78-89
NON-PATENT LITERATURE 2: Weng, Q. and Quattrochi, D. A., “Urban Remote Sensing”, CRC Press, 2007
NON-PATENT LITERATURE 3: Hu, J., Razdan, A., Femiani, J. C., Cui, M. and Wonka, P., “Road network extraction and intersection detection from aerial images by tracking road footprints”, IEEE Transactions on Geoscience and Remote Sensing, Vol. 45, No. 12, pp. 4144-4157, 2007
NON-PATENT LITERATURE 4: Movaghati, S., Moghaddamjoo, A. and Tavakoli, A., “Road extraction from satellite images using particle filtering and extended Kalman filtering”, IEEE Transactions on Geoscience and Remote Sensing, Vol. 48, No. 7, pp. 2807-2817, 2010
NON-PATENT LITERATURE 5: Tso, B. and Mather, P. M., “Classification methods for remotely sensed data—2nd ed.”, CRC Press, 2009
NON-PATENT LITERATURE 6: Soille, P. and Pesaresi, M., “Advances in mathematical morphology applied to geoscience and remote sensing”, IEEE Transactions on Geoscience and Remote Sensing, Vol. 40, No. 9, pp. 2042-2055, 2002
NON-PATENT LITERATURE 7: Benediktsson, J. A., Pesaresi, M. and Amason, K., “Classification and feature extraction for remote sensing images from urban areas based on morphological transformations”, IEEE Transactions on Geoscience and Remote Sensing, Vol. 41, No. 9, pp. 1940-1949, 2003
NON-PATENT LITERATURE 8: Benediktsson, J. A., Palmason, J. A. and Sveinsson, J. R., “Classification of hyperspectral data from urban areas based on extended morphological profiles”, IEEE Transactions on Geoscience and Remote Sensing, Vol. 43, No. 3, pp. 480-491, 2005
NON-PATENT LITERATURE 9: Bellens, R., Gautama, S., Martinez-Fonte, L., Philips, W., Chan, J.C.-W., Canters, F., “Improved Classification of VHR Images of Urban Areas Using Directional Morphological Profiles”, IEEE Transactions on Geoscience and Remote Sensing, Vol. 46, No. 10, pp. 2803-2813, 2008
NON-PATENT LITERATURE 10: Tuia, D., Pacifici, F., Kanevski, M. and Emery, W. J., “Classification of Very High Spatial Resolution Imagery Using Mathematical Morphology and Support Vector Machines”, IEEE Transactions on Geoscience and Remote Sensing, Vol. 47, No. 11, pp. 3866-3879, 2009
NON-PATENT LITERATURE 11: Canny, J., “A Computational Approach to Edge Detection”, IEEE Transactions on Pattern Analysis and Machine Intelligence, Vol. PAMI-8, No. 6, pp. 679-698, 1986
NON-PATENT LITERATURE 12: Zhong, J. and Ning, R., “Image denoising based on wavelets and multifractals for singularity detection”, IEEE Transactions on Image Processing, Vol. 14, No. 10, pp. 1435-1447, 2005
NON-PATENT LITERATURE 13: Tonazzini, A., Bedini, L. and Salerno, E., “A Markov model for blind image separation by a mean-field EM algorithm”, IEEE Transactions on Image Processing, Vol. 15, No. 2, pp. 473-482, 2006
NON-PATENT LITERATURE 14: Berlemont, S, and Olivo-Marin, J.-C., “Combining Local Filtering and Multiscale Analysis for Edge, Ridge, and Curvilinear Objects Detection”, IEEE Transactions on Image Processing, Vol. 19, No. 1, pp. 74-84, 2010
NON-PATENT LITERATURE 15: Ding, J., Ma, R. and Chen, S., “A Scale-Based Connected Coherence Tree Algorithm for Image Segmentation”, IEEE Transactions on Image Processing, Vol. 17, No. 2, pp. 204-216, 2008
NON-PATENT LITERATURE 16: Chien, S. Y., Ma, S. Y. and Chen, L. G., “Efficient moving object segmentation algorithm using background registration technique”, IEEE Transactions on Circuits and Systems for Video Technology, Vol. 12, No. 7, pp. 577-586, 2002
NON-PATENT LITERATURE 17: Tsai, V. J. D., “A comparative study on shadow compensation of color aerial images in invariant color models”, IEEE Transactions on Geoscience and Remote Sensing, Vol. 44, No. 6, pp. 1661-1671, 2006
NON-PATENT LITERATURE 18: Ma, H., Qin, Q. and Shen, X., “Shadow Segmentation and Compensation in High Resolution Satellite Images”, Proceedings of IEEE International Geoscience and Remote Sensing Symposium, 2008, Vol. 2, pp. II-1036-II-1039, 2008

### SUMMARY OF INVENTION

### Technical Problem

[DTM estimation method, DTM estimation program, DTM estimation device, and method for creating 3-dimensional building model]

Since the above DTM is based on estimation unlike LiDAR data, it is inevitable that error or erroneous recognition will occur to a certain extent in the DTM, but it is important to suppress such error or erroneous recognition as much as possible. As a result of DTM estimation for various ground surfaces, it was found out that, particularly, in the case where there is a river on a land that is flat as a whole, it is difficult to recognize a point set of data of a river bed, a bank, a bridge, or the like as a ground surface. In addition, a rooftop parking area (uppermost portion of a building) with a slope gradually ascending from a road was sometimes erroneously recognized as a ground surface.

Considering the above conventional problem, an object of the present invention is to enhance the accuracy of a DTM estimated based on LiDAR data.

[Region extraction method, region extraction program, and region extraction device]

The above factor (i), in other words, provides a problem of how to cope with the case where the edge of a region is not sufficiently obtained. In addition, how to eliminate unnecessary edges from edges excessively extracted by the above factor (iii) is also a problem. Here, the problem of (iii) is considered to be also relevant to the problem of (i). For example, in NON-PATENT LITERATURE 11, Canny proposes an edge extraction operator robust to noise. This is considered to be one of representative edge extraction operators that have been widely used conventionally. In addition, a method of eliminating noise by using a wavelet (for example, NON-PATENT LITERATURE 12), a method of utilizing an average value (for example, NON-PATENT LITERATURE 13), and a method of utilizing a multiple resolution image (for example, NON-PATENT LITERATURE 14), have been reported.

In addition, with regard to the above factor (ii), study cases of recovering the brightness value of a shadow region have been reported (for example, NON-PATENT LITERATURES 15 to 18). However, for example, as far as a recovery result in NON-PATENT LITERATURE 18 is considered, a problem that the boundary between a region that has been originally a shadow region, and a non-shadow region, clearly appears on an image after recovery, and a problem that determination of a correction value for a shadow region is difficult and the recovery may be excessive, are still unsolved.

Considering the above conventional problem, an object of the present invention is to provide a technique for extracting more accurately a region of a building based on data of an aerial photograph or the like.

### Solution to Problem

[DTM estimation method, DTM estimation program, DTM estimation device, and method for creating 3-dimensional building model]

(1) The present invention relates to a DTM estimation method for, based on laser scanner data of an earth's surface obtained by an aircraft, estimating a DTM which is elevation data of only a ground surface for a predetermined range of the laser scanner data, by using a computer, the DTM estimation method including: linking pixels where no data is present within a unit grid in the predetermined range, to extract a river region; setting a first maximum allowable slope value and provisionally estimating a DTM for data excluding the river region; calculating a local slope from the estimated DTM; and if the slope exceeds a predetermined value, setting a second maximum allowable slope value greater than the first maximum allowable slope value and estimating a DTM again.

In the above DTM estimation method, a river region is excluded in estimation of a DTM, whereby deterioration of the accuracy of the DTM due to searching for a ground surface across a river can be prevented. In addition, if a local slope exceeds a predetermined value in the estimated DTM, the second maximum allowable slope value greater than the first maximum allowable slope value is set to estimate a DTM again, whereby ground surface data that could not be searched for in the processing for the first time is added, thus improving the accuracy of the DTM estimation.

(2) In the DTM estimation method according to the above (1), the second maximum allowable slope value may be increased or decreased in accordance with features of a terrain and an urban landscape.

In this case, it becomes possible to perform optimum DTM estimation in accordance with the features of a terrain and an urban landscape.

(3) Another aspect of the present invention is a method for creating 3-dimensional building model including the DTM estimation method according to the above (1), the method for creating 3-dimensional building model including: dividing the laser scanner data into a DTM estimated by the DTM estimation method and non-ground surface data; and determining, for each of regions in the non-ground surface data, whether or not normal vectors having directions to be paired are present, and estimating a shape of a roof based on a result of the determination.

In this case, accurate non-ground surface data is obtained based on a DTM that has been accurately estimated, and then whether or not there are normal vectors having directions to be paired is determined, whereby the shapes of roofs such as a gable roof and a hip roof as well as a flat roof can be estimated to create a 3-dimensional building model.

(4) In the method for creating 3-dimensional building model according to the above (3), the regions may be extracted in advance by preferentially extracting at least rectangular shapes from data of an aerial photograph in the predetermined range.

In this case, by using a rectangle which is highly likely to be a shape of a roof, identification accuracy for regions of roofs can be enhanced and more accurate 3-dimensional building model can be created.

(5) Still another aspect of the present invention is a DTM estimation program (or DTM estimation program storage medium) for, based on laser scanner data of an earth's surface obtained by an aircraft, estimating a DTM which is elevation data of only a ground surface for a predetermined range of the laser scanner data, the DTM estimation program (or DTM estimation program storage medium) causing a computer to realize: a function of linking pixels where no data is present within a unit grid in the predetermined range, to extract a river region; a function of setting a first maximum allowable slope value and provisionally estimating a DTM for data excluding the river region; a function of calculating a local slope from the estimated DTM; and a function of, if the slope exceeds a predetermined value, setting a second maximum allowable slope value greater than the first maximum allowable slope value and estimating a DTM again.

In the above DTM estimation program (or DTM estimation program storage medium), a river region is excluded in estimation of a DTM, whereby deterioration of the accuracy of the DTM due to searching for a ground surface across a river can be prevented. In addition, if a local slope exceeds a predetermined value in the estimated DTM, the second maximum allowable slope value greater than the first maximum allowable slope value is set to estimate a DTM again, whereby ground surface data that could not be searched for in the processing for the first time is added, thus improving the accuracy of the DTM estimation.

(6) Still another aspect of the present invention is a DTM estimation device for, based on laser scanner data of an earth's surface obtained by an aircraft, estimating a DTM which is elevation data of only a ground surface for a predetermined range of the laser scanner data, the DTM estimation device including: an input device for reading laser scanner data of an earth's surface obtained by an aircraft; a river extraction section for linking pixels where no data is present within a unit grid in the predetermined range of the laser scanner data, to extract a river region; a DTM estimation section for setting a first maximum allowable slope value and provisionally estimating a DTM for data excluding the river region, calculating a local slope from the estimated DTM, and if the slope exceeds a predetermined value, setting a second maximum allowable slope value greater than the first maximum allowable slope value and estimating a DTM again; a display section for displaying the estimated DTM.

In the above DTM estimation device, a river region is excluded in estimation of a DTM, whereby deterioration of the accuracy of the DTM due to searching for a ground surface across a river can be prevented. In addition, if a local slope exceeds a predetermined value in the estimated DTM, the second maximum allowable slope value greater than the first maximum allowable slope value is set to estimate a DTM again, whereby ground surface data that could not be searched for in the processing for the first time is added, thus improving the accuracy of the DTM estimation.

[Region extraction method, region extraction program, and region extraction device]

(7) The present invention further relates to a region extraction method for, based on data of a photograph taken from an aircraft or a satellite, extracting a region of a building by using a computer, the region extraction method including: setting a plurality of different discretization widths and discretizing brightness values of the data into a plurality of values discretely set by using each of the discretization widths; linking pixels having an identical value in a discretized image obtained by the discretization, and extracting a region having a shape close to a rectangle as a candidate of a region of a building; and employing, as a region of a building, a region among a plurality of region sets extracted for the respective plurality of different discretization widths, in decreasing order of closeness of shape to a rectangle.

In the above region extraction method, owing to the discretization, even a region having a texture with great dispersion of brightness value can be extracted as one region. In addition, points having an identical value are linked and a region having a shape close to a rectangle is extracted, thereby facilitating elimination of regions other than buildings. In addition, among a plurality of region sets extracted for the respective plurality of different discretization widths, a region is extracted as a region of a building in decreasing order of closeness of shape to a rectangle, thereby realizing a function equal to application of a spatial smoothing parameter that is locally optimum.

(8) In the region extraction method according to the above (7), a rectangle index defined by (area of a region/area of rectangle surrounding the region) may be used as an index representing closeness of shape to a rectangle.

In this case, the degree of “closeness” of a shape close to a rectangle can be simply and properly represented as an index.

(9) In the region extraction method according to the above (7) or (8), in the extraction, if a shape of a region obtained by merging regions adjacent to each other becomes further close to a rectangle, the merging may be able to be performed.

In this case, a region of a building can be recognized more accurately.

(10) In the region extraction method according to the above (8), it is preferable that if the rectangle index is smaller than a predetermined value, the corresponding region is not employed as a region of a building.

In this case, a region that is less likely to be a building can be excluded from a target of extraction.

(11) In the region extraction method according to the above (7), a region estimated as vegetation based on RGB brightness values thereof may be excluded from a target of the extraction.

In this case, in light of the color feature of a vegetation region, the region can be excluded from a target of extraction.

(12) Another aspect of the present invention is a region extraction program (or region extraction program storage medium) for, based on data of a photograph taken from an aircraft or a satellite, extracting a region of a building, the region extraction program (or region extraction program storage medium) causing a computer to realize: a function of setting a plurality of different discretization widths and discretizing brightness values of the data into a plurality of values discretely set by using each of the discretization widths; a function of linking pixels having an identical value in a discretized image obtained by the discretization, and extracting a region having a shape close to a rectangle as a candidate of a region of a building; and a function of employing, as a region of a building, a region among a plurality of region sets extracted for the respective plurality of different discretization widths, in decreasing order of closeness of shape to a rectangle.

(13) Still another aspect of the present invention is a region extraction device for, based on data of a photograph taken from an aircraft or a satellite, extracting a region of a building, the region extraction device including: a function of setting a plurality of different discretization widths and discretizing brightness values of the data into a plurality of values discretely set by using each of the discretization widths; a function of linking pixels having an identical value in a discretized image obtained by the discretization, and extracting a region having a shape close to a rectangle as a candidate of a region of a building; and a function of employing, as a region of a building, a region among a plurality of region sets extracted for the respective plurality of different discretization widths, in decreasing order of closeness of shape to a rectangle.

In the region extraction program (or region extraction program storage medium)/region extraction device according to the above (12) or (13), owing to the discretization, even a region having a texture with great dispersion of brightness value can be extracted as one region. In addition, points having an identical value are linked and a region having a shape close to a rectangle is extracted, thereby facilitating elimination of regions other than buildings. In addition, among a plurality of region sets extracted for the respective plurality of different discretization widths, a region is extracted as a region of a building in decreasing order of closeness of shape to a rectangle, thereby realizing a function equal to application of a spatial smoothing parameter that is locally optimum.

### Advantageous Effects of Invention

[DTM estimation method, DTM estimation program, DTM estimation device, and method for creating 3-dimensional building model]

According to the present invention, the accuracy of DTM estimation can be improved.

[Region extraction method, region extraction program, and region extraction device]

According to the present invention, a region of a building can be more accurately extracted based on photograph data of an aerial photograph or the like.

### BRIEF DESCRIPTION OF DRAWINGS

In FIG. 1, (a) is an aerial photograph of an area around Kiyomizu-dera Temple, Hokan-ji Temple, Kodai-ji Temple in Higashiyama Ward, Kyoto City. In this area, flatlands where buildings are densely located, and hilly areas are present in a mixed manner. (b) is a drawing showing an elevation distribution (DSM including uppermost portions of buildings and the like) indicated by LiDAR data obtained by an aircraft in a color coded manner for convenience sake (it is noted that this drawing is not represented in color).

In FIG. 2, (a) is ground surface data extracted in the processing for the first time, and (b) is ground surface data extracted in the processing for the second time.

In FIG. 3, (a) shows a DTM obtained by the processing for the first time, and (b) shows a final DTM obtained by the processing for the second time.

In FIG. 4, (a) is an aerial photograph of an area around Gojo-dori street, Nakagyo Ward, Kyoto City. In this area, a river is present on a flatland where buildings are densely located. (b) is a drawing showing an elevation distribution (DSM including uppermost portions of buildings and the like) indicated by LiDAR data obtained by an aircraft in a color coded manner for convenience sake (it is noted that this drawing is not represented in color).

In FIG. 5, (a) is ground surface data extracted in the processing for the first time, and (b) is ground surface data extracted in the processing for the second time.

In FIG. 6, (a) shows a DTM obtained by the processing for the first time, and (b) shows a final DTM obtained by the processing for the second time.

In FIG. 7, (a) is an aerial photograph of an area around Fushimi Momoyama, Fushimi Ward, Kyoto City. In this area, a river with a large bank is present on a flatland where buildings are densely located. (b) is a drawing showing an elevation distribution (DSM including uppermost portions of buildings and the like) indicated by LiDAR data obtained by an aircraft in a color coded manner for convenience sake (it is noted that this drawing is not represented in color). Further, (c) shows a DTM obtained by the processing for the first time, and (d) shows a final DTM obtained by the processing for the second time.

In FIG. 8, (a) is a partially enlarged drawing of the LiDAR data shown in (b), and (b) is a photograph of the corresponding area taken on the ground as seen from an arrow direction in (a). Further, (c) shows a DTM (enlarged drawing) obtained by the processing for the first time, and (d) shows a final DTM (enlarged drawing) obtained by the processing for the second time.

In FIG. 9, (a) is a drawing showing an elevation distribution (DSM including uppermost portions of buildings and the like) of a parking area and the periphery thereof near Kiyomizu-dera Temple in Higashiyama Ward, Kyoto City, indicated by LiDAR data obtained by an aircraft, in a color coded manner for convenience sake (it is noted that this drawing is not represented in color). (b) is an aerial photograph thereof.

In FIG. 10, (a) shows a DTM obtained by the processing for the first time, and (b) shows a final DTM obtained by the processing for the second time.

In FIG. 11, (a) is an aerial photograph (75 m×75 m) of an urban area and (b) is a result of a region division.

In FIG. 12, (a) and (b) are 3-dimensional building wire frame models. (a) shows 2-dimensional shapes and (b) shows 3-dimensional shapes.

In FIG. 13, (a) is an aerial photograph (75 m×75 m) of an urban area including a high-rise building and (b) is a result of a region division.

In FIG. 14, (a) and (b) are 3-dimensional building wire frame models. (a) shows 2-dimensional shapes and (b) shows 3-dimensional shapes.

In FIG. 15, (a) is an aerial photograph (75 m×75 m) of an urban area including a tall tree adjacent to a building and (b) is a result of a region division.

In FIG. 16, (a) and (b) are 3-dimensional building wire frame models. (a) shows 2-dimensional shapes and (b) shows 3-dimensional shapes.

In FIG. 17, (a) is an aerial photograph (75 m×75 m) of an urban area including many hip roofs and (b) is a result of a region division.

In FIG. 18, (a) and (b) are 3-dimensional building wire frame models. (a) shows 2-dimensional shapes and (b) shows 3-dimensional shapes.

FIG. 19 is a block diagram showing an example of the configuration of a DTM estimation device.

FIG. 20 is a flowchart showing a DTM estimation method or an estimation program.

In FIG. 21, (a) shows a normal vector of a gable roof and (b) shows a normal vector of a hip roof.

FIG. 22 is an example of an aerial photograph of an urban area (Higashiyama Ward, Kyoto City) where houses are densely located.

FIG. 23 is a photograph, taken on a ground, of an area from Hokan-ji Temple, Higashiyama Ward, Kyoto City to around Higashioji-dori street.

FIG. 24 is a block diagram showing an example of a computer device for executing a region extraction method.

FIG. 25 is a conceptual diagram of linking of pixels.

FIG. 26 is a conceptual diagram of rectangle index calculation.

FIG. 27 is a conceptual diagram of merging of a target region and regions adjacent thereto.

FIG. 28 shows a result of edge extraction for an urban area (area 1) where low-rise buildings are densely located.

FIG. 29 shows a result of edge extraction for an urban area (area 2) including high-rise buildings and low-rise buildings in a mixed manner.

FIG. 30 shows a result of edge extraction for an area (area 3) including a tall tree adjacent to a building.

FIG. 31 shows a result of edge extraction for an area (area 4) including many hip roof buildings.

FIG. 32 shows a result of region extraction for the area 1.

FIG. 33 shows a result of region extraction for the area 2.

FIG. 34 shows a result of region extraction for the area 3.

FIG. 35 shows a result of region extraction for the area 4.

FIG. 36 shows a comparison result of region extraction for the area 1.

FIG. 37 shows a comparison result of region extraction for the area 2.

FIG. 38 shows a comparison result of region extraction for the area 3.

FIG. 39 shows a comparison result of region extraction for the area 4.

### DESCRIPTION OF EMBODIMENTS

[DTM estimation method, DTM estimation program, DTM estimation device, and method for creating 3-dimensional building model]

<<Estimation of DTM>>

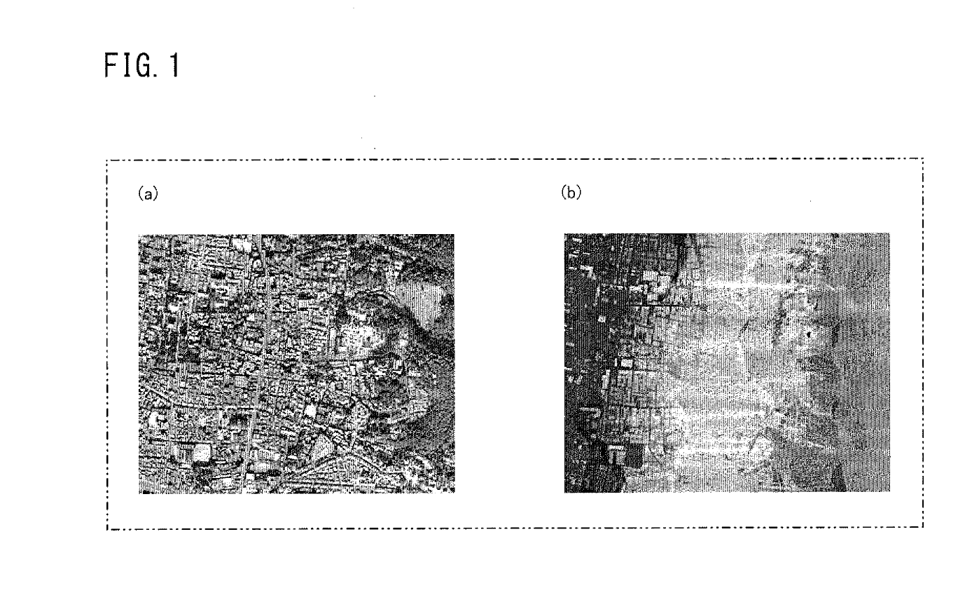

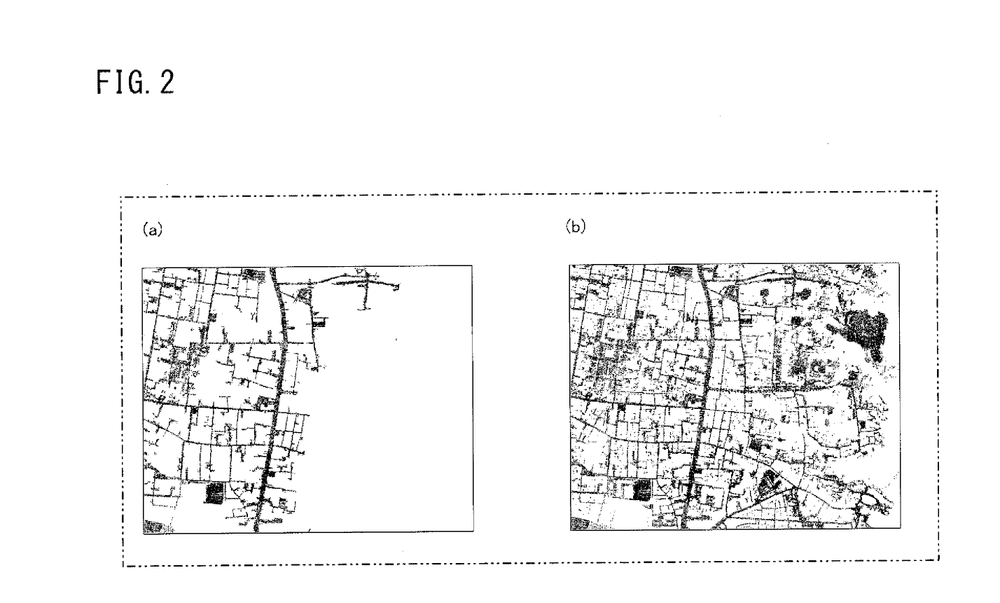

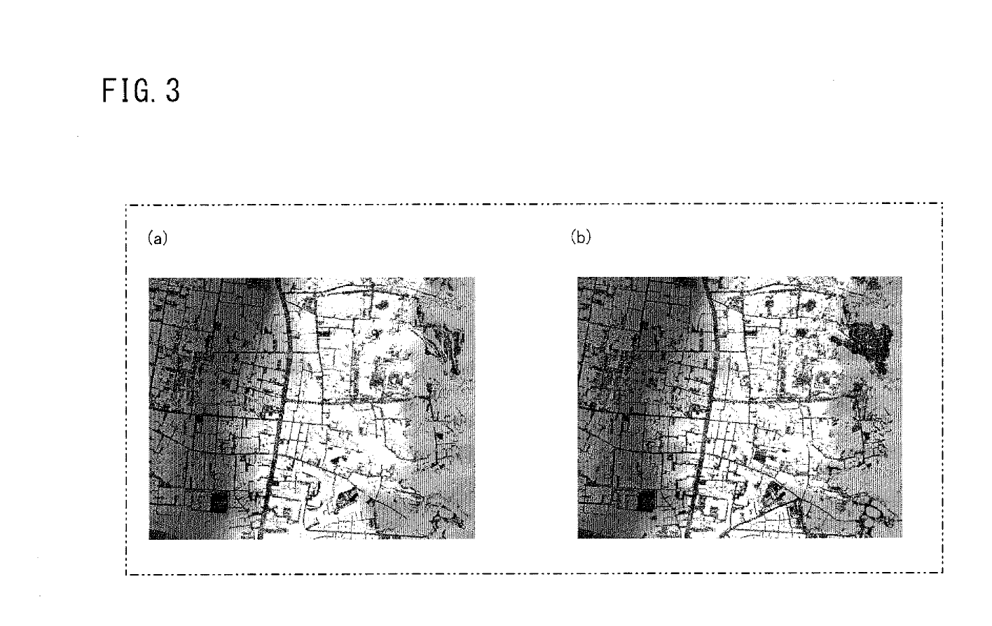

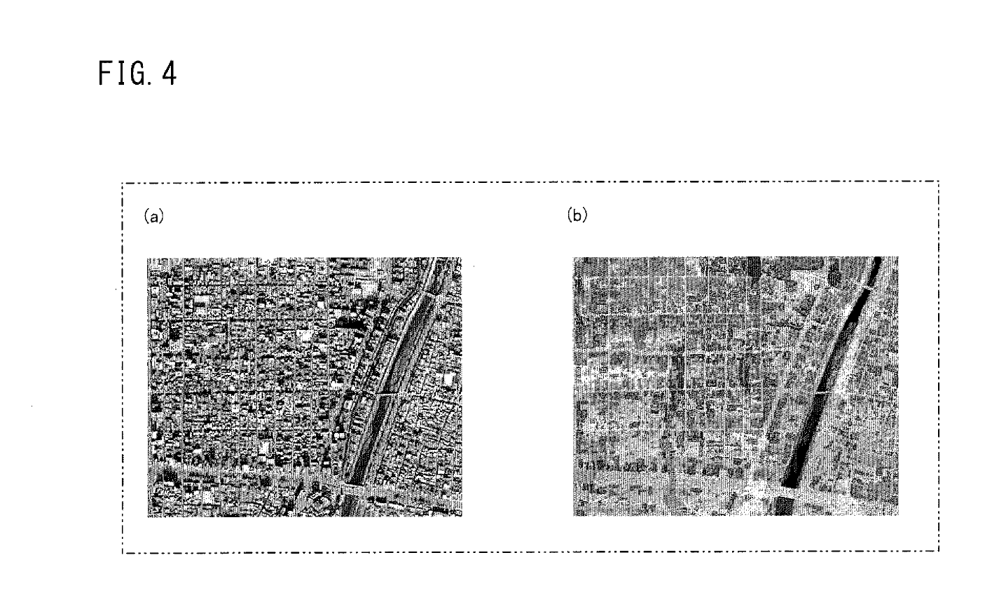

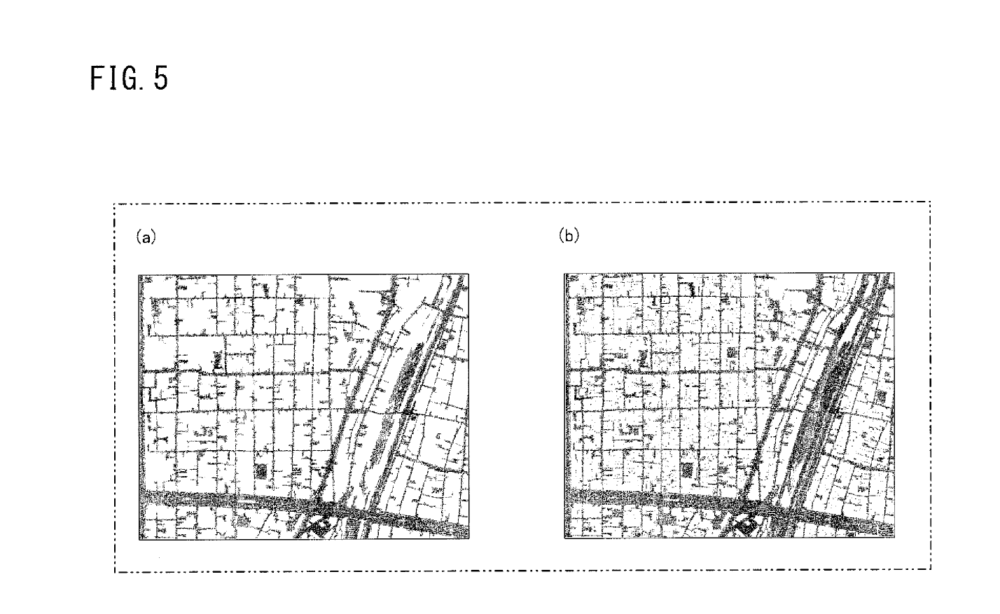

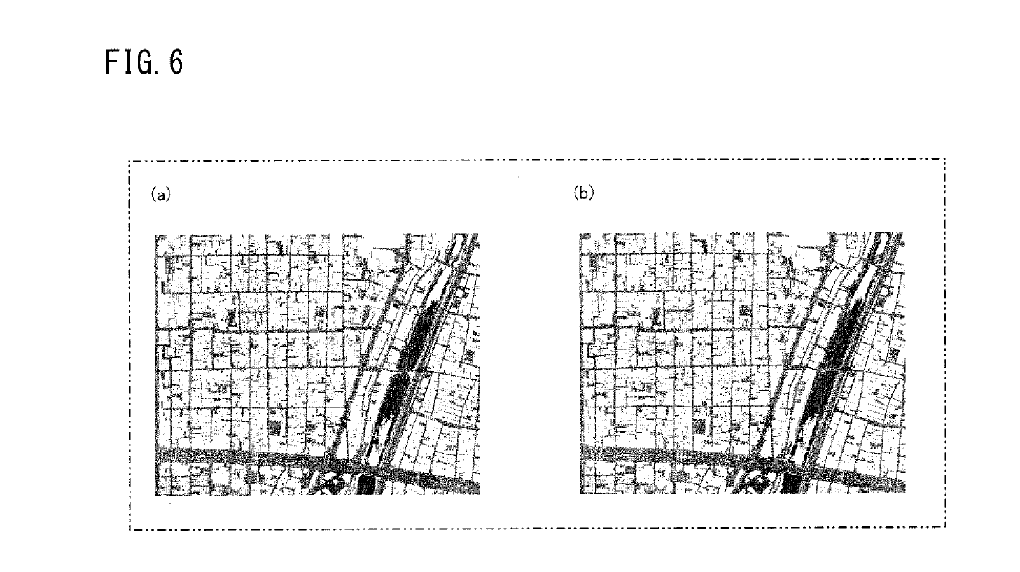

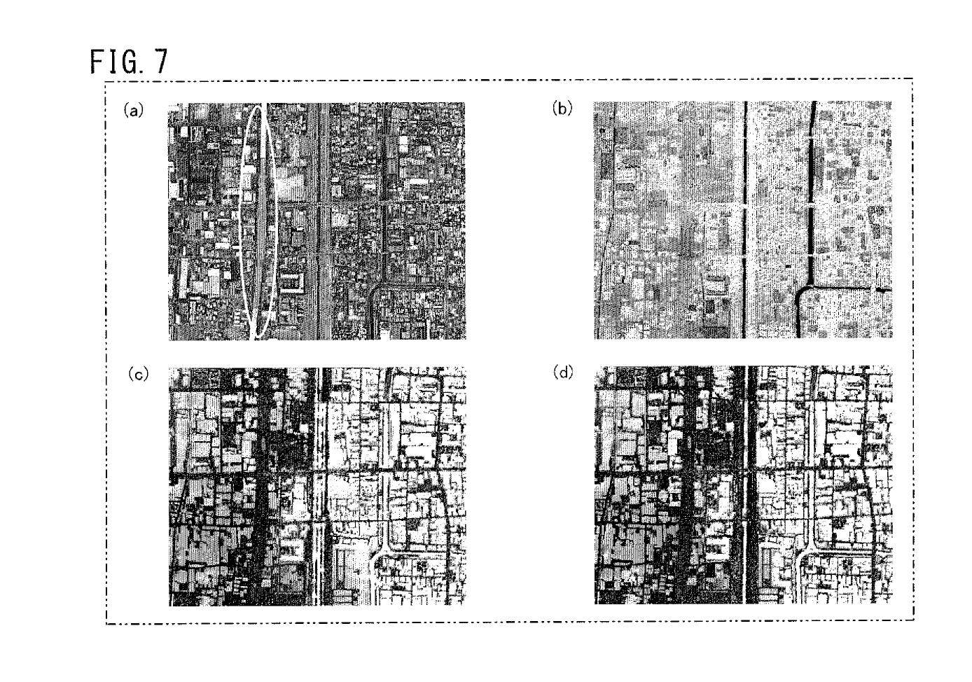

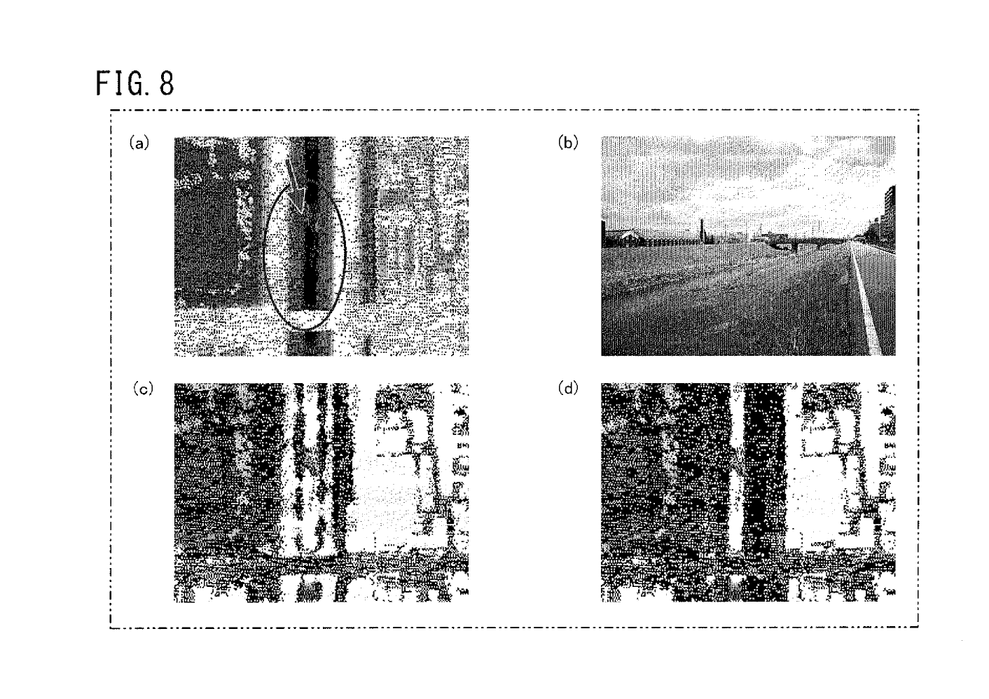

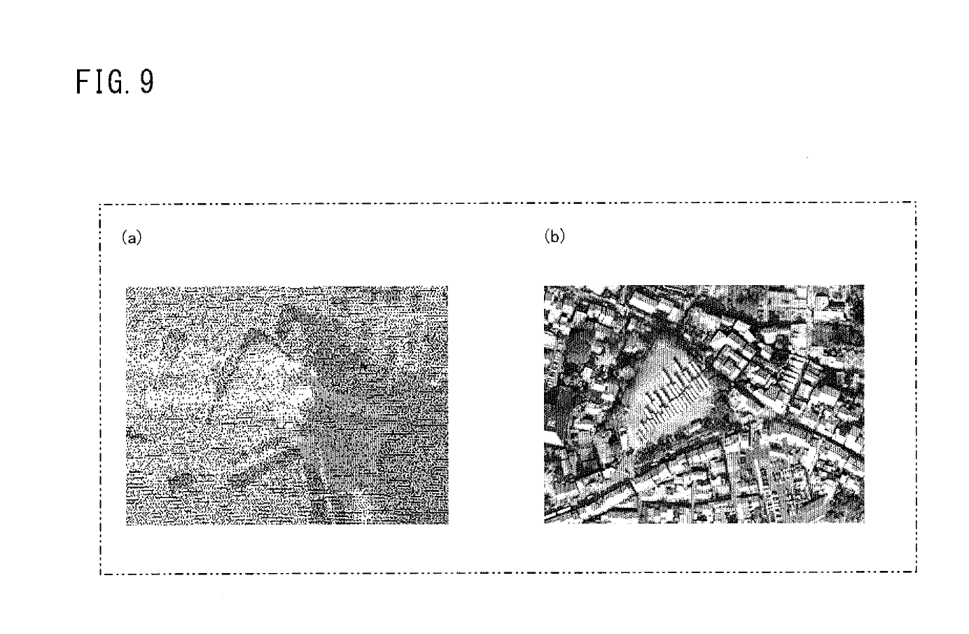

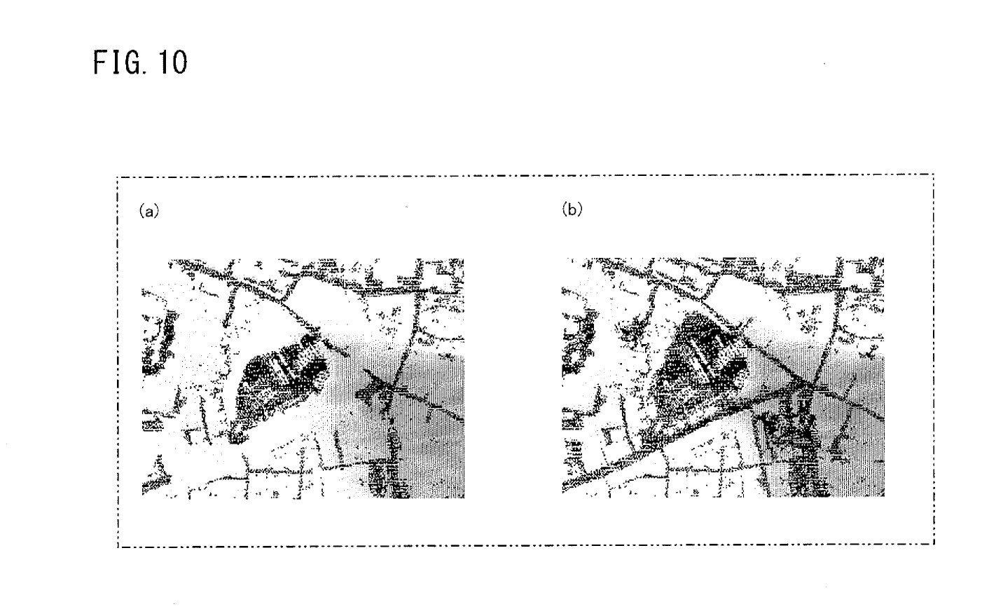

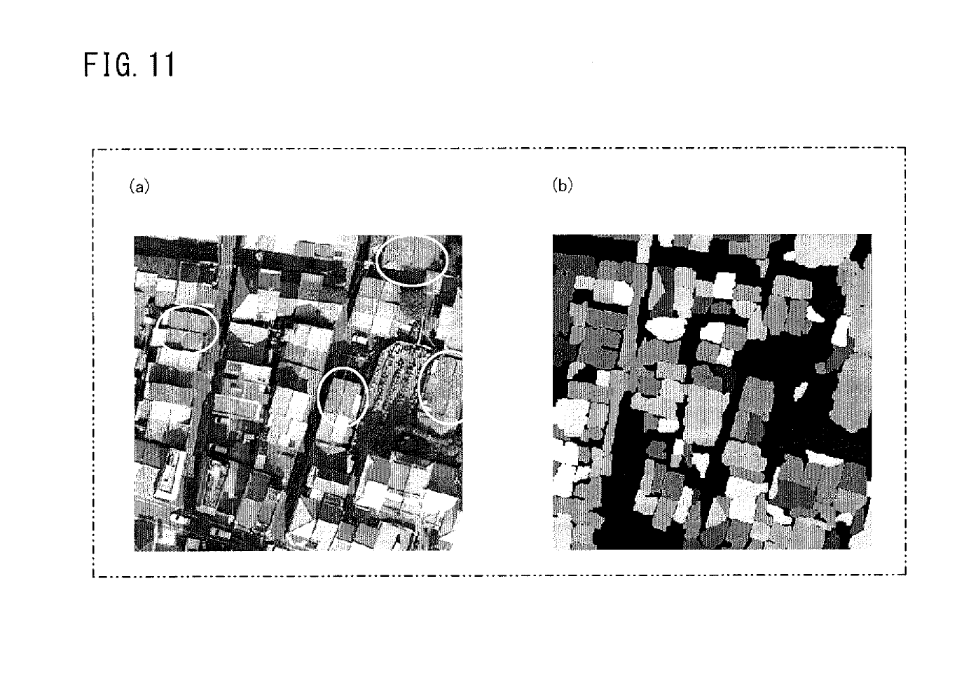

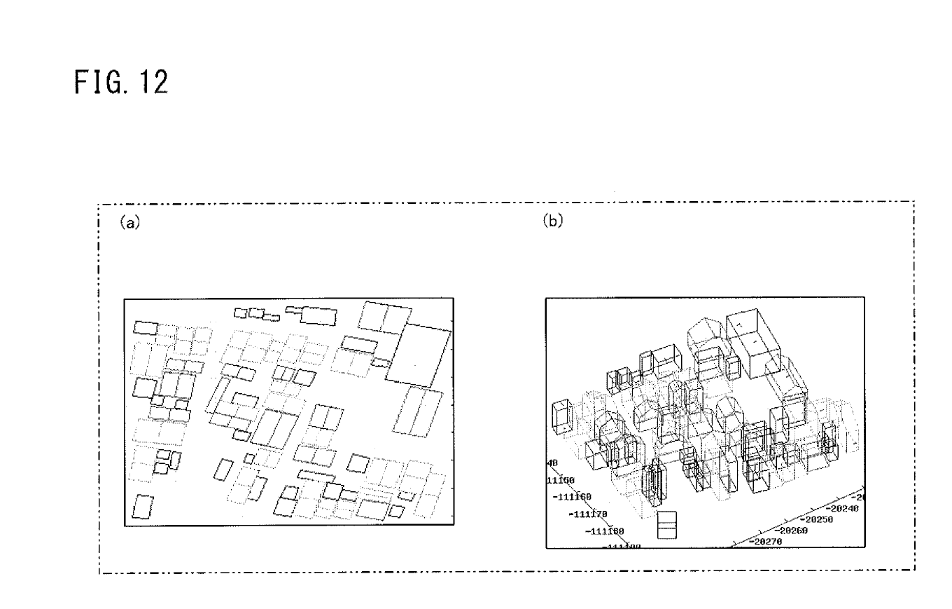

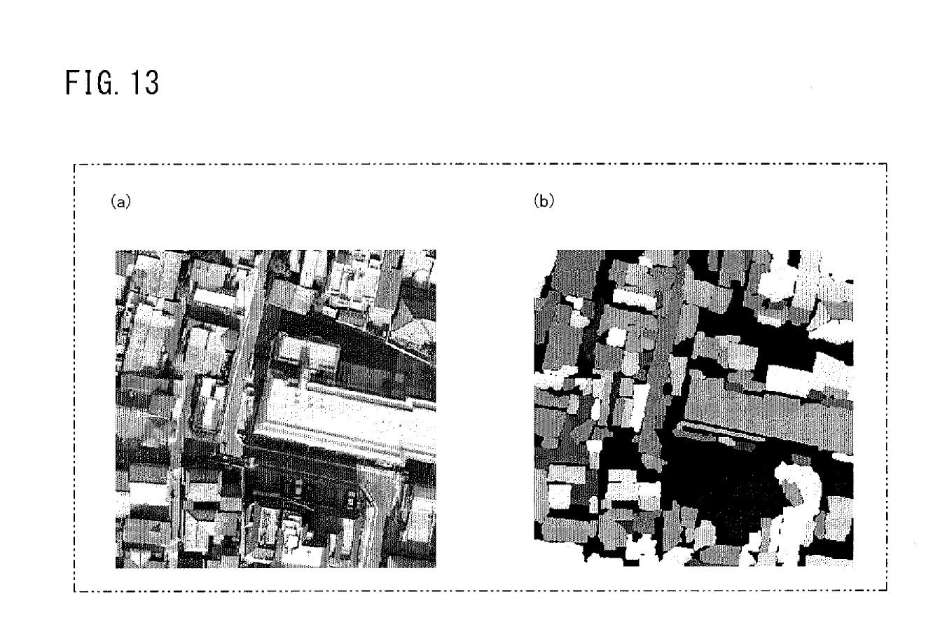

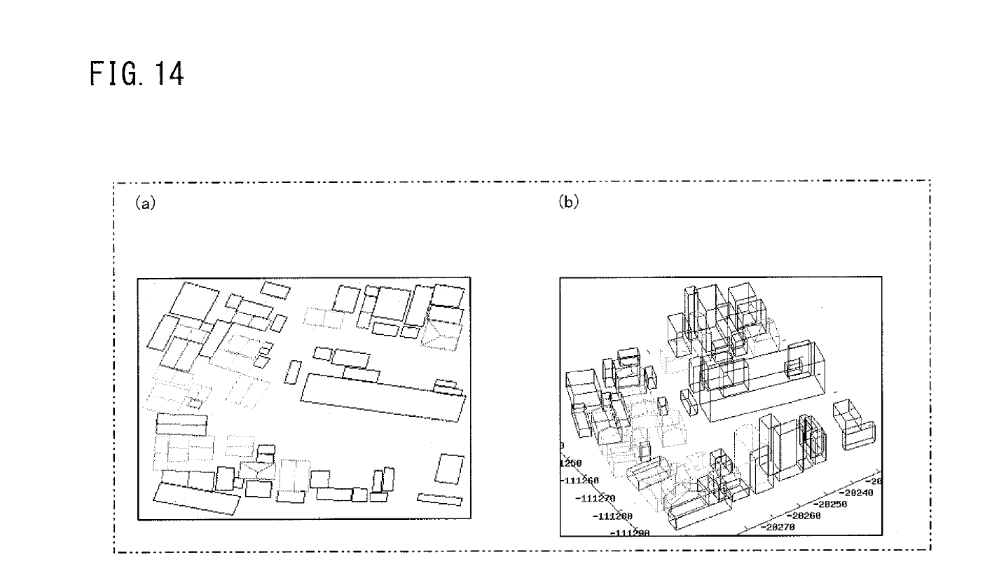

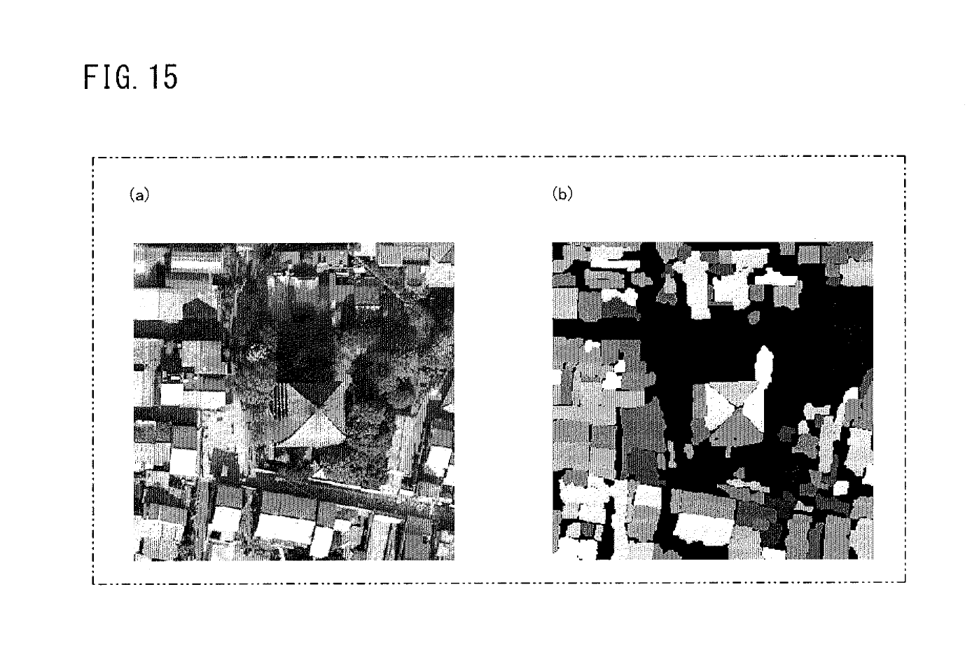

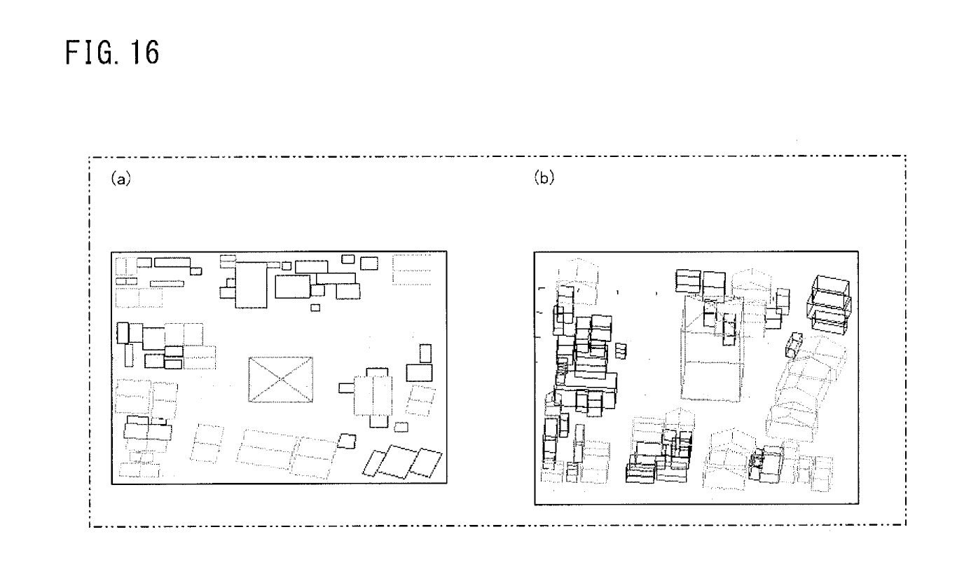

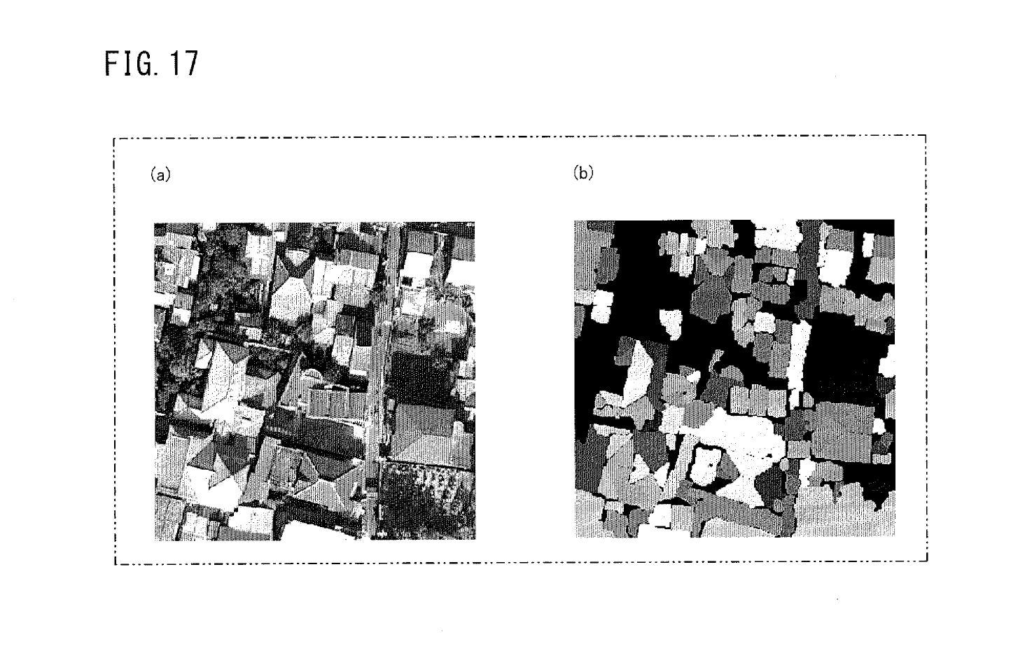

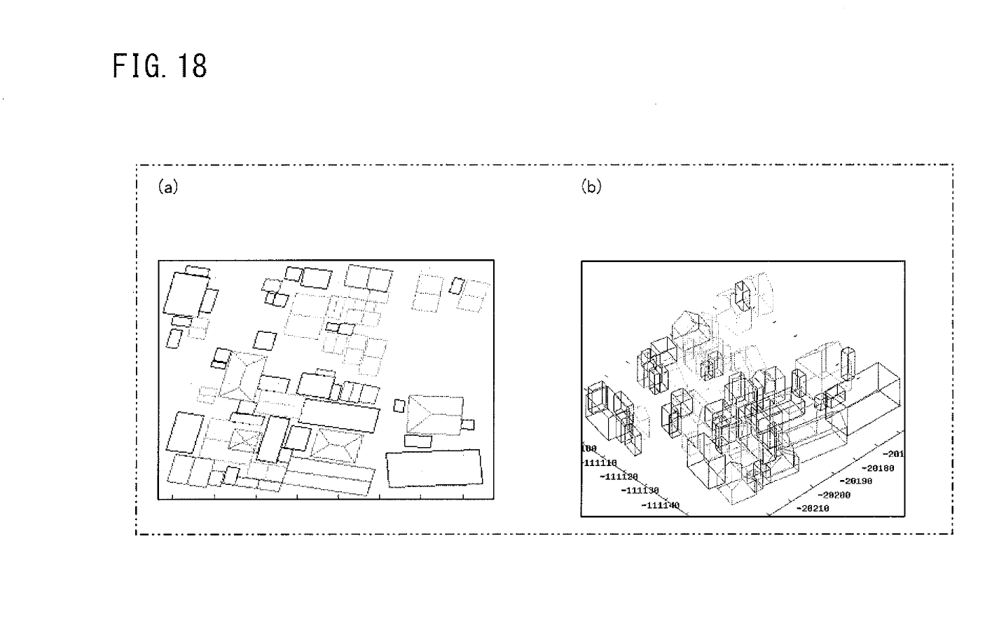

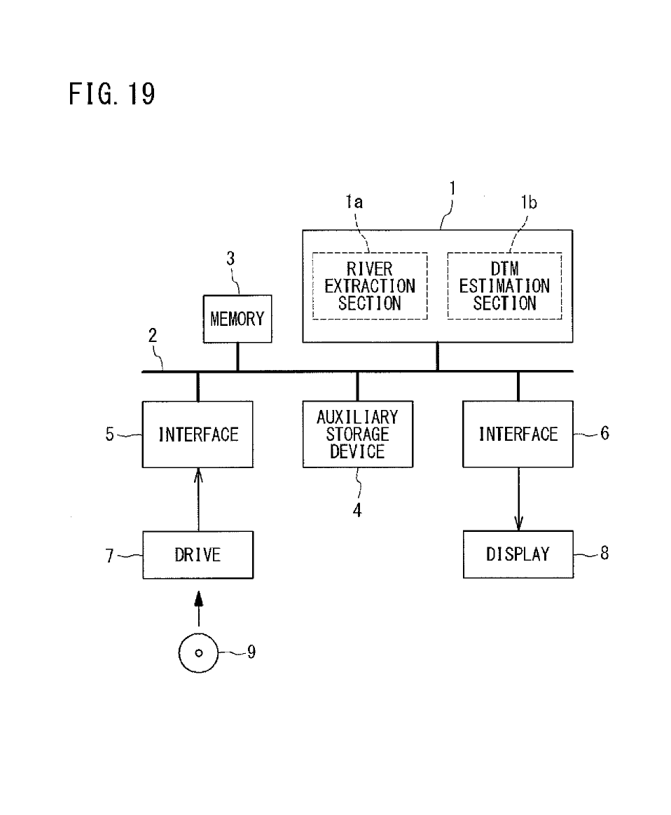

FIG. 19 is a block diagram showing an example of the configuration of a device for estimating a DTM that is elevation data of only a ground surface for a predetermined range based on laser scanner data of an earth's surface obtained by an aircraft. The DTM estimation device includes a CPU 1, a memory 3 connected to the CPU 1 via a bus 2, an auxiliary storage device 4 such as a hard disk, interfaces 5 and 6, and a drive 7 and a display 8 respectively connected to the interfaces 5 and 6. Typically, the DTM estimation device is a personal computer. When a storage medium 9 such as a CD or a DVD storing LiDAR data (laser scanner data) is mounted on the drive 7 as an input device, LiDAR data becomes ready to be read.

The CPU 1 roughly includes a river extraction section 1a and a DTM estimation section 1b as internal functions realized by software. Although the details of these functions will be described later, the river extraction section has a function of extracting a river region by linking pixels where no data is present within a unit grid in a predetermined range of LiDAR data (laser scanner data). The DTM estimation section 1b has a function of, for data excluding a river region, setting a first maximum allowable slope value and estimating a provisional DTM, calculating a local slope from the estimated DTM, and then, in the case where the slope exceeds a predetermined value, setting a second maximum allowable slope value greater than the first maximum allowable slope value and estimating a DTM again. The estimated DTM can be displayed on the display 8 as a display section.

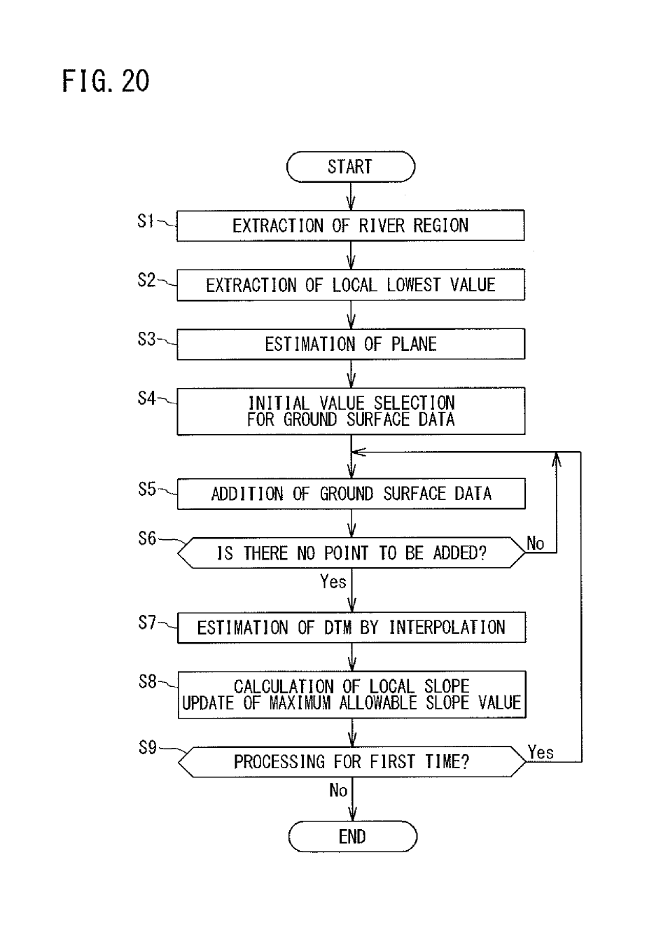

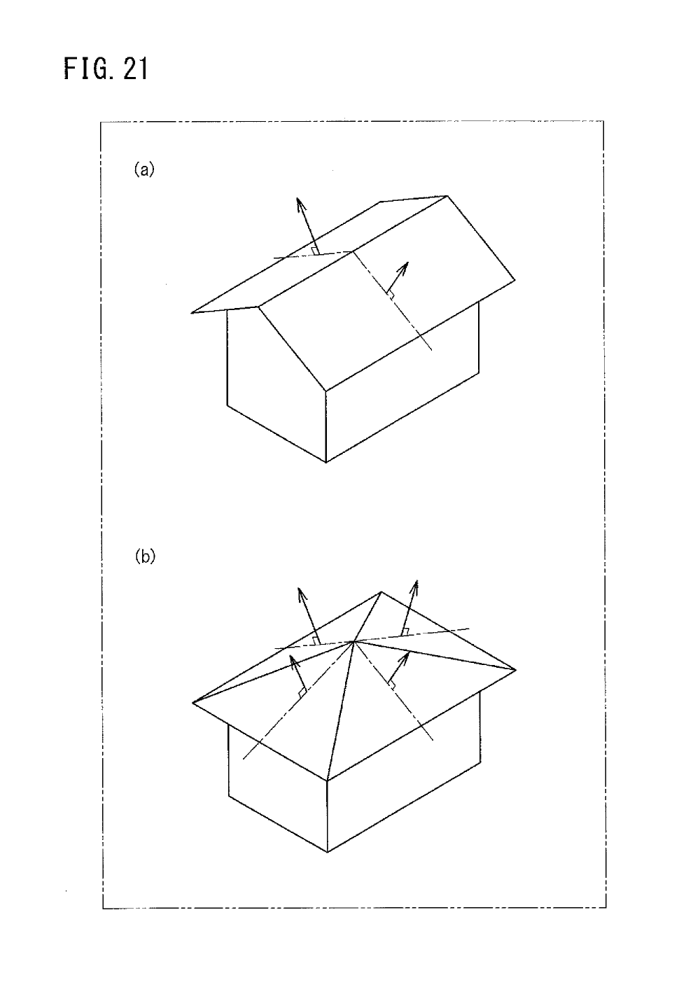

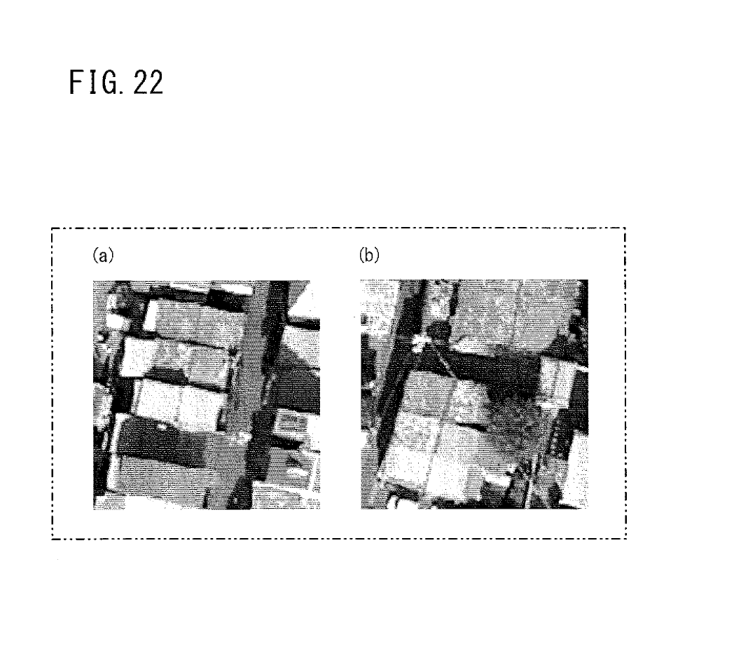

Next, the above functions of the CPU 1, i.e., the DTM estimation method or the estimation program will be described with reference to a flowchart in FIG. 20. It is noted that the program is stored in the auxiliary storage device 4 (FIG. 19) as a storage medium and executed, using the memory 3, by the CPU 1. It is noted that the DTM estimation program to be executed is installed from various storage media into the auxiliary storage device 4, or downloaded from a specific server storing the DTM estimation program via a network and then installed into the auxiliary storage device 4. That is, the DTM estimation program can also exist and be distributed as a storage (record) medium.

The LiDAR data used herein is a commercial product, in which, for example, an average point density is 1 point/1 m² and only last pulse data (last reception data reflected on the ground surface) having 3-dimensional coordinate data is included. It is noted that usable data is not limited thereto. For example, data continuous from first to last, which is called full-wave type, can be also used.

In FIG. 20, first, the CPU 1 extracts a river region from LiDAR data (step S1). Specifically, in an image whose unit grid is set to 1 m grid, pixels where no data (point) is present are linked, and then a resultant region in the case of occupying an area equal to or larger than a predetermined area is extracted as a river region.

Next, the CPU 1 extracts a local lowest value from the LiDAR data (step S2). Specifically, in extraction for the first time, a local lowest value is extracted within a window of 50 m×50 m, and then in extraction for the second time, a local lowest value is searched for within a window of 25 m×25 m. If the second local lowest value does not greatly increase (for example, by 50 cm or less) as compared to the first local lowest value, and a slope calculated from two points in a 3-dimensional coordinate system that indicate the first and second local lowest values is equal to or smaller than a first maximum allowable slope value (for example, 3 degrees), the first local lowest value is updated to the second local lowest value. Otherwise, the first local lowest value is employed.

Next, the CPU 1 estimates a plane from LiDAR data by least-squares method (step S3). At this time, in the case where RMSE (Root Mean Square Errors) of points with respect to a plane is small, the points are regarded as being on a common plane. Specifically, for example, equations of planes are calculated by using all point sets included in regions of 4 m×4 m, and then if RMSE with respect to the planes are equal to or smaller than 10 cm, the equations of the planes are given to all such point sets. These planes are candidates of a road surface, and may include a slope surface. However, the possibility that an extreme slope surface is a road is very low. Therefore, a vertical component of a normal line of each plane is limited to 0.9 or greater, for example.

Then, the CPU 1 selects, as an initial value (initial point set) of ground surface data, a point whose altitude difference from the point of the local lowest value is small and that is within a slope as seen from the local lowest value, among the points on the above plane (step S4).

Subsequently, the CPU 1 searches for a point in the neighborhood of the ground surface data, calculates a distance from the point to the plane by using the equation of the plane of the ground surface data, and then if the distance is equal to or smaller than a threshold value (for example, 10 cm), treats the point as a candidate of a point to be added as the ground surface data. Then, if a slope between the point and the ground surface data is equal to or smaller than the maximum allowable slope value (for example, 3 degrees), the CPU 1 adds the point as the ground surface data (step S5).

The addition of the ground surface data (step S5) is performed until there is no point to be added (step S6). If there is no point to be added, extraction of ground surface data is completed.

Subsequently, the CPU 1 searches for ground surface data in the neighborhood of a location where no ground surface data is present, and performs interpolation to estimate a DTM (step S7). In the searching, if a river region is encountered, the CPU 1 stops searching in the corresponding direction.

Next, the CPU 1 calculates a local slope based on the estimated DTM (step S8). In the slope calculation, first, the average value of ground surface heights is calculated for each unit region of 21 m×21 m. Then, with regard to the ground surface height of one region, eight neighborhood regions (up-down, right-left, diagonal) therearound are searched for, a slope is calculated from a distance between the centers of regions and a difference between the average values of ground surface heights, and then the greatest slope value is obtained. If the slope is equal to or greater than a threshold value (for example, 4.5 degrees), the maximum allowable slope value is set to be greater, to be updated as a second maximum allowable slope value (for example, updated to 4.5 degrees).

Subsequently, the CPU 1 determines whether or not the present processing of steps S5 to S8 is for the first time (step S9). In the case of first time, the determination result is “Yes”, so the CPU 1 executes steps S5 and S6 again based on the second maximum allowable slope value. Here, since the second maximum allowable slope value greater than the first maximum allowable slope value has been set, a location locally having a steep slope is added as the ground surface data. That is, point cloud data of a bank of a river, a hilly area, and the like, which has been left out of the added data in step S5 for the first time, is extracted and added as the ground surface data. As a result, estimation of a DTM is performed more accurately than for the first time. It is noted that in step S9 for the second time, the determination result is “No”, and thus the process is ended.

Improvement in the accuracy of a DTM by the above processing will be shown by examples in FIGS. 1 to 10.

### Example 1

In FIG. 1, (a) is an aerial photograph of an area around Kiyomizu-dera Temple, Hokan-ji Temple, Kodai-ji Temple in Higashiyama Ward, Kyoto City. In this area, flatlands where buildings are densely located, and hilly areas are present in a mixed manner. In FIG. 1, (b) is a drawing showing an elevation distribution (DSM including uppermost portions of buildings and the like) indicated by LiDAR data obtained by an aircraft in a color coded manner for convenience sake (it is noted that this drawing is not represented in color). In (b), a blackish portion on the left has a relatively low altitude, and a blackish portion on the right has a relatively high altitude. A whitish portion in the middle has an altitude intermediate therebetween. Since a DSM includes buildings and the like, a ground surface is unclear.

In FIG. 2, (a) is ground surface data extracted in the processing for the first time, and (b) is ground surface data extracted in the processing for the second time. Black portions in these drawings represent a ground surface (ground base surface). In FIG. 3, (a) shows a DTM obtained by the processing for the first time, and (b) shows a final DTM obtained by the processing for the second time. In each of FIG. 2 and FIG. 3, as is obvious from comparison between (a) and (b), data of the details of a hilly area (on the viewer's right) and a flatland has been obtained with a significantly improved accuracy by the processing for the second time.

### Example 2

In FIG. 4, (a) is an aerial photograph of an area around Gojo-dori street, Nakagyo Ward, Kyoto City. In this area, a river is present on a flatland where buildings are densely located. In FIG. 4, (b) is a drawing showing an elevation distribution (DSM including uppermost portions of buildings and the like) indicated by LiDAR data obtained by an aircraft in a color coded manner for convenience sake (it is noted that this drawing is not represented in color).

In FIG. 5, (a) is ground surface data extracted in the processing for the first time, and (b) is ground surface data extracted in the processing for the second time. In FIG. 6, (a) shows a DTM obtained by the processing for the first time, and (b) shows a final DTM obtained by the processing for the second time. In this example, no drastic difference appears between the first time and the second time. In other words, in a flat terrain with no local steep slope, the processing for the second time uses the same first maximum allowable slope value as in the processing for the first time, and therefore excessive extraction is prevented.

### Example 3

In FIG. 7, (a) is an aerial photograph of an area around Fushimi Momoyama, Fushimi Ward, Kyoto City. In this area, a river with a large bank is present on a flatland where buildings are densely located. In FIG. 7, (b) is a drawing showing an elevation distribution (DSM including uppermost portions of buildings and the like) indicated by LiDAR data obtained by an aircraft in a color coded manner for convenience sake (it is noted that this drawing is not represented in color). It is noted that an ellipse in (a) indicates an express way, and the express way had not been constructed yet at the time when the LiDAR data in (b) was obtained. In FIG. 7, (c) shows a DTM obtained by the processing for the first time, and (d) shows a final DTM obtained by the processing for the second time.

In FIG. 8, (a) is a partially enlarged drawing of the LiDAR data shown in (b) of FIG. 7, and (b) of FIG. 8 is a photograph of the corresponding area taken on the ground as seen from an arrow direction in (a). In FIG. 8, (c) shows a DTM (enlarged drawing) obtained by the processing for the first time, and (d) shows a final DTM (enlarged drawing) obtained by the processing for the second time. In (d), a white line extending in the up-down direction at the center is a river, and blackish portions on the right and left thereof are banks. From comparison between (c) and (d), it is found that the bank which has not been treated as a ground surface in the processing for the first time is accurately recognized as a ground surface in the processing for the second time.

### Example 4

In FIG. 9, (a) is a drawing showing an elevation distribution (DSM including uppermost portions of buildings and the like) of a parking area and the periphery thereof near Kiyomizu-dera Temple in Higashiyama Ward, Kyoto City, indicated by LiDAR data obtained by an aircraft, in a color coded manner for convenience sake (it is noted that this drawing is not represented in color). (b) is an aerial photograph thereof. In FIG. 10, (a) shows a DTM obtained by the processing for the first time, and (b) shows a final DTM obtained by the processing for the second time. From comparison between (a) and (b), it is found that the parking area (black portion at the center) whose shape has not been completely recognized as a ground surface in the processing for the first time has been accurately recognized as a ground surface in the processing for the second time.

### Example 5

Although not shown, DTMs for the first time and the second time were also obtained for a rooftop parking area of a building, and there was almost no change therebetween. In this case, the parking area was not erroneously recognized as a ground surface.

<<Conclusion>>

In the above DTM estimation method/program (or program storage medium)/device, a river region is excluded in estimation of a DTM, whereby deterioration of the accuracy of the DTM due to searching for a ground surface across a river can be prevented. In addition, if a local slope exceeds a predetermined value in the estimated DTM, the second maximum allowable slope value greater than the first maximum allowable slope value is set to estimate a DTM again, whereby ground surface data that could not be searched for in the processing for the first time is added, thus improving the accuracy of the DTM estimation.

It is noted that the second maximum allowable slope value may be increased or decreased in accordance with the features of a terrain and an urban landscape. It has been confirmed that 4.5 degrees are preferred for the case of Kyoto City. It is assumed that even a value equal to or greater than 4.5 degrees may be suitable for a land with more slopes than in Kyoto City. On the other hand, for a land with slopes less than in Kyoto City, it is assumed that a value smaller than 4.5 degrees (but greater than 3 degrees) may be suitable. By experimentally selecting an optimum value, it becomes possible to perform optimum DTM estimation in accordance with the features of a terrain and an urban landscape.

<<Creation of 3-Dimensional Building Model>>

By performing calculation of (DSM−DTM) using LiDAR data and a DTM accurately estimated by the above processing, a ground surface is eliminated on the data, whereby only data of the heights of objects present on a ground, such as buildings and trees, can be obtained. Hereinafter, a method for creating a 3-dimensional building model by using such data will be described. First, region division for a building and the like using an aerial photograph will be described.

(Region Division)

The outline of region division is as follows. First, in order to extract also a region having a texture with great dispersion of brightness value, the brightness values are discretized into a small number of values before execution of region division. A plurality of widths of brightness values for discretization are prepared in order to cope with different degrees of dispersion. In order to preferentially extract a region having a shape close to a rectangle, an index referred to as a rectangle index is calculated. Considering the possibility of separation by shadow, if the rectangle index increases when adjacent regions are combined, these regions are merged.

Hereinafter, a specific example of region division will be described for reference though the description reaches the details.

(1) Ndisc kinds of discretization widths are set for brightness values in any one band of an image of 1 bite (brightness value range: 0 to 255)×3 bands (RGB). Under each discretization width, Noff kinds of different offset values are applied, and the brightness values of the image are discretized. For example, in the case of “discretization width for brightness value=40” and “offset number=5”, the offset value width is 8, so that Noff kinds of discretized images corresponding to the respective offset values={0, 8, 16, 24, 32} are obtained. Under the offset value=0, an identical discretization value is assigned to brightness values of “0 to 39” of an original image. Thus, brightness values are discretized into seven intervals including “40 to 79”, “80 to 119”, “120 to 159”, “160 to 199”, “200 to 239”, and “240 to 255”, as well as “0 to 39”. In the present experiment, the following parameters were used.

Used band: Red (R) band

Discretization width Δd of brightness value={40, 30, 20}

Offset number Noff=5

Offset value width Δoff=Δd/Noff={8, 6, 4}

(2) In each discretized image, searching is performed in four directions and pixels having the same value are linked and extracted as a region. A large region equal to or larger than a certain area (in the present experiment, 6400 pixels: hereinafter, each indicates a value employed in the experiment) is eliminated. In addition, with regard to a small region smaller than a certain area (80 pixels), if a region equal to or larger than a certain area is present at the periphery thereof, they are merged, and if no such region is present, said small region is eliminated. Thereafter, an edge of each region is extracted.

(3) The edges obtained from the Noff kinds of discretized images for one discretization width are overlapped into one image.

(4) Edges having an intensity equal to or greater than a certain intensity are left, and edges to be linked with such edges are also extracted. At this time, a region that should normally have been closed is often not closed due to an influence of noise or the like. Therefore, even at a portion having no edge, if presence of a linear edge is recognized at the periphery thereof, the edges are linked with each other.

(5) Label numbers are assigned to regions closed by edges, and a region appearing to be a vegetation region is eliminated judging from the RGB brightness values. As in step (2), a large region equal to or larger than a certain area (6400 pixels) is eliminated. In addition, with regard to a small region equal to or smaller than a certain area (in the present experiment, 30 pixels), if a region equal to or larger than a certain area is present at the periphery thereof they are merged, and if no such region is present, said small region is eliminated.

(6) An index referred to as a rectangle index of each region is calculated as follows.

(i) A first axis and a second axis are determined from 2-dimensional coordinates of a collection (referred to as an edge set) of edges of a region.

(ii) The presence range of each region is represented by values on the first axis and the second axis, and (maximum value−minimum value+1) on the first axis is multiplied by (maximum value−minimum value+1) on the second axis, to obtain the area of a rectangle surrounding the region.

(iii) A value, “actual area of a region/area of a rectangle surrounding the region”, is defined as a rectangle index.

(iv) If a rectangle index is smaller than a certain value (0.4), it is considered that there is a high possibility that the corresponding region is not a building, and therefore said region is excluded.

(7) Regions in the neighborhood of one region A are searched for to determine whether or not each region satisfies the following conditions.

(i) A rectangle index when merged with the region A becomes greater than a rectangle index of each single region.

(ii) The rectangle index is equal to or greater than a designated threshold value (0.7).

(iii) The difference between the average brightness values of both regions is equal to or smaller than a certain value (30).

Among neighborhood regions satisfying these conditions, a region having the greatest rectangle index when merged is set as a candidate for merging, which is provisionally defined as a region B. Also for the region B, searching is performed in the same manner, and then if the region A satisfies all the conditions (i) to (iii) and the rectangle index when they are merged is the greatest, the regions A and B are merged.

(8) Regions equal to or larger than a certain area, obtained under the Ndisc kinds of discretization widths, are selected in decreasing order of rectangle index. It is noted that if even a part of such a region overlaps with a region that has been already selected, said region is not selected.

(9) Selection is performed again for regions that have not been selected. At this time, if a part overlapping with a region that has been already selected is smaller than a certain rate (in the present experiment, 30%) and smaller than a certain area (30 pixels), only the left part that does not overlap is additionally selected as a new region. It is noted that a rectangle index is calculated also for the part that does not overlap, and the part is selected only in the case where the rectangle index is equal to or greater than a threshold value (0.45).

(10) A hollow part inside each region is filled.

(3-Dimensional Building Model)

A region obtained by the region division may not be a roof-based region, that is, roofs having slopes to be paired on a single building or roofs of one building and another building may not be divided from each other. In addition, in the region division, some roofs or buildings may fail to be extracted, or to the contrary, some trees or roads may be extracted. However, such modeling failure is reduced by taking the following measures.

The estimated DTM is eliminated from LiDAR data. For calculation of a plane of a roof and its normal vector, an allowable value of RMSE is provided, thereby deleting most of trees. In the case where opposing roofs on a gable roof building are not divided from each other, if there is a high possibility that they are mixed judging from the distribution status of normal vectors, such a roof is divided to generate a gable roof. In the situation where roofs on one side of adjacent gable roof buildings are not divided from each other (the numbers of roofs on both sides of each ridge are in one-to-two relationship), the region that is not divided is divided into two roofs, to generate two pairs of one-to-one roofs, thus generating two gable roof buildings.

Focusing on placements of buildings in a dense urban area, by using information such as a slope and a normal vector of a roof surface, determination for gable roof, hip roof, and flat roof is performed, whereby a building 3-dimensional model closer to the original shape is created. Specifically, principal azimuths are determined for such point sets that the horizontal and vertical distances between neighborhood point sets are within certain values, and then a ridge and a boundary of a building are determined based on the azimuth, whereby the more realistic orientation of the building can be determined.

Specifically, filtering processing of separating a ground surface and a non-ground surface with use of a DTM is performed for LiDAR data which is point cloud data in a 3-dimensional coordinate system. Normal vectors on regions of roofs and buildings are calculated from non-ground surface data. If six or more points are present in a region of 9 m×9 m, an equation of a plane is calculated for the points. Then, if RMSE is equal to or smaller than 10 cm, normal vectors are given to all such point sets used in the calculation. If the normal of a region is inclined, a region to be paired therewith is searched for.

In the non-ground surface data, point data is classified into point sets such that the horizontal and vertical distances between any points closest to each other in each point set are within certain values. Then, principal azimuths are determined for only point cloud data corresponding to regions of roofs and buildings, among the classified point sets. Wire frame models are sequentially created for hip roofs, gable roofs, and then the other roofs, in this order. The creation of each model is performed such that a ridge and a boundary are parallel or perpendicular to the principal azimuth of the point cloud data.

A hip roof is generated when there are two pairs of roofs to be paired. A gable roof is generated when there are regions containing roofs to be paired, so that respective parts of the gable roof are generated in both regions. In the case where there is a region whose normal vector distribution indicates a mixed state of a plurality of normal lines, if the normal vectors are clearly separated when the region is divided into two parts, a gable roof is generated. Otherwise, a flat roof is generated. It is noted that (a) in FIG. 21 shows a normal vector of a gable roof and (b) shows a normal vector of a hip roof.

For the other roofs, flat roofs are generated. In the case where there are points that have not been extracted as a building but are positioned equal to or higher than a certain height from a ground surface and are present on a specific plane, such points are selected to be included in a final result.

The region division and the creation of a 3-dimensional building model based on the processing as described above will be shown by examples in FIGS. 11 to 18.

### Example 1

In FIG. 11, (a) is an aerial photograph (75 m×75 m) of an urban area. (b) is a result of a region division, which is shown in a color coded manner for convenience sake (though colors are not displayed in this drawing) but the colors themselves are not significant. As shown in FIG. 11(b), boundaries of roofs are generally recognized. In addition, the features of a gable and a hip roof are recognized at some portions. In FIG. 12, (a) and (b) are 3-dimensional building wire frame models. (a) shows 2-dimensional shapes and (b) shows 3-dimensional shapes. It is found that the shapes of roofs such as a flat, a gable roof, and a hip roof appear clearly.

### Example 2

In FIG. 13, (a) is an aerial photograph (75 m×75 m) of an urban area including a high-rise building. (b) is a result of a region division, which is shown in a color coded manner for convenience sake (though colors are not displayed in this drawing) but the colors themselves are not significant. As shown in (b), boundaries of roofs are generally recognized. In addition, the features of a gable roof and a hip roof are recognized at some portions. In FIG. 14, (a) and (b) are 3-dimensional building wire frame models. (a) shows 2-dimensional shapes and (b) shows 3-dimensional shapes. It is found that the shapes of roofs such as a flat, a gable roof and a hip roof appear clearly.

### Example 3

In FIG. 15, (a) is an aerial photograph (75 m×75 m) of an urban area including a tall tree adjacent to a building. (b) is a result of a region division, which is shown in a color coded manner for convenience sake (though colors are not displayed in this drawing) but the colors themselves are not significant. As shown in (b), boundaries of roofs are generally recognized. In addition, the features of a gable roof and a hip roof are recognized at some portions. In FIG. 16, (a) and (b) are 3-dimensional building wire frame models. (a) shows 2-dimensional shapes and (b) shows 3-dimensional shapes. It is found that the shapes of roofs such as a flat, a gable roof, and a hip roof appear clearly.

### Example 4

In FIG. 17, (a) is an aerial photograph (75 m×75 m) of an urban area including many hip roofs. (b) is a result of a region division, which is shown in a color coded manner for convenience sake (though colors are not displayed in this drawing) but the colors themselves are not significant. As shown in (b), boundaries of roofs are generally recognized. In addition, the features of a gable roof and a hip roof are recognized at some portions. In FIG. 18, (a) and (b) are 3-dimensional building wire frame models. (a) shows 2-dimensional shapes and (b) shows 3-dimensional shapes. It is found that the shapes of roofs such as a flat, a gable roof, and a hip roof appear clearly.

<<Conclusion>>

As described above, accurate non-ground surface data is obtained based on a DTM that has been accurately estimated, and then whether or not there are normal vectors having directions to be paired is determined, whereby the shapes of roofs such as a gable roof and a hip roof as well as a flat roof can be estimated to create a 3-dimensional building model.

In addition, since regions for creating a 3-dimensional building model are extracted in advance, identification accuracy for regions of roofs can be enhanced and more accurate 3-dimensional building model can be created.

It is noted that the embodiment disclosed herein is merely illustrative in all aspects and should not be recognized as being restrictive. The scope of the present invention is defined by the scope of the claims, and is intended to include meaning equivalent to the scope of the claims and all modifications within the scope.

[Region extraction method, region extraction program, and region extraction device]

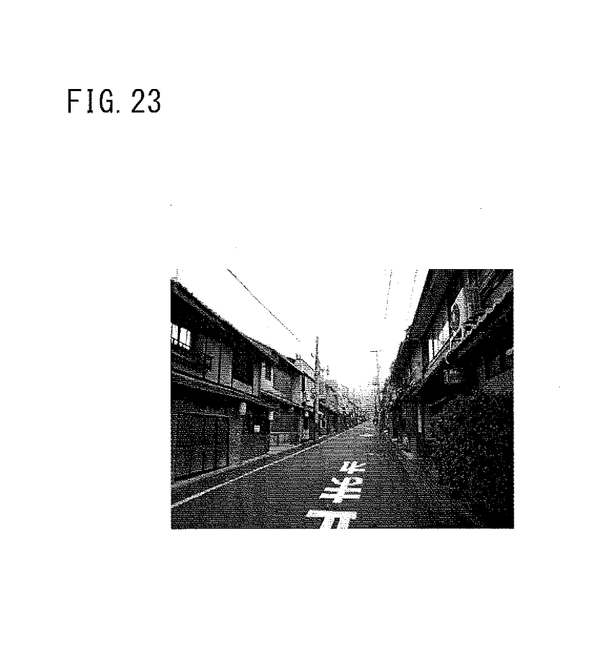

Hereinafter, a region extraction method and a region extraction program according to one embodiment of the present invention will be described. As a model area for region extraction, an area from Hokan-ji Temple, Higashiyama Ward, Kyoto City to around Higashioji-dori street was targeted. In this area, wooden buildings stand in a row, each fully occupying its site width. FIG. 23 is a photograph of this area taken on a ground. As the aerial photograph data of this area, data (commercial product) with 25 cm resolution subjected to ortho (orthogonal projection) processing was used. This data has been adapted to a plane orthogonal coordinate system. It is noted that side surfaces of buildings slightly appear even though ortho processing has been performed, but this does not cause a particular problem in practice.

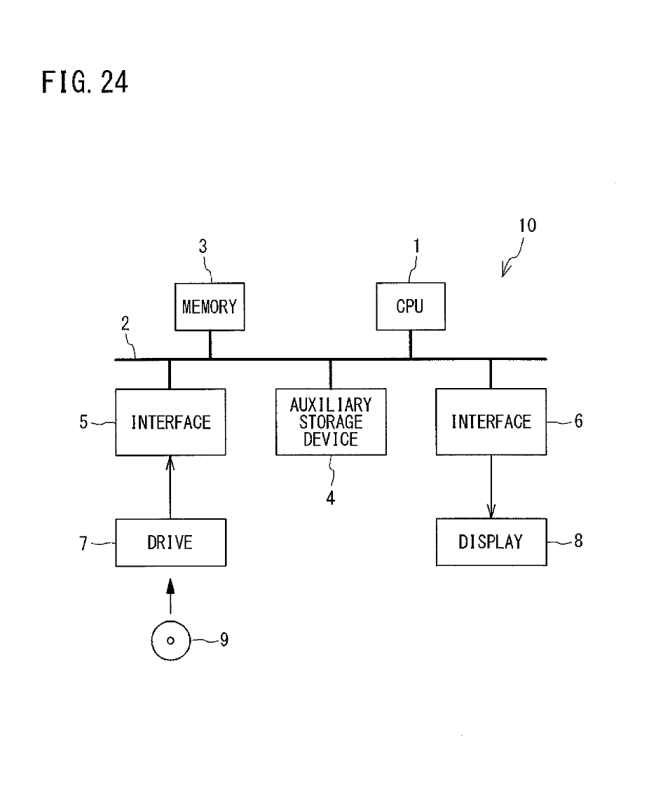

Next, the region extraction method and the region extraction program for extracting regions of buildings (boundary shapes of roofs) will be described. FIG. 24 is a block diagram showing an example of a computer device 10 for executing the region extraction method. The region extraction program causes the computer device 10 to realize such a function. The computer device 10 having the function of the region extraction program installed thereon is a region extraction device according to one embodiment of the present invention.

The computer device 10 includes a CPU 1, a memory 3 connected to the CPU 1 via a bus 2, an auxiliary storage device 4 such as a hard disk, interfaces 5 and 6, and a drive 7 and a display 8 respectively connected to the interfaces 5 and 6. Typically, the computer device 10 is a personal computer. When a storage medium 9 such as a CD or a DVD storing an aerial photograph is mounted on the drive 7 as an input device, data of the aerial photograph becomes ready to be read. It is noted that separately from the aerial photograph, the region extraction program to be executed is installed from various storage media into the auxiliary storage device 4, or downloaded from a specific server storing the region extraction program via a network and then installed into the auxiliary storage device 4. That is, the region extraction program can also exist and be distributed as a storage (record) medium.

<<Procedure of Region Extraction>>

Hereinafter, the region extraction (major steps of the method and the program) will be described in detail.

The outline of region extraction is as follows. In order to effectively extract also a roof having a texture with great dispersion of brightness value, the brightness values are discretized into a predetermined number of values, and each region having an identical discretized value is labeled. Regions having shapes close to a rectangle which can be seen on buildings in a plane view are preferentially extracted. Among region sets obtained by applying a plurality of different discretization widths, regions are sequentially employed in decreasing order of closeness to a rectangle, thereby realizing the same processing as in the case of applying a spatial smoothing parameter that is locally optimum. Hereinafter, each step will be described in detail.

(First Step)

First, N_{disc} kinds of discretization widths are set for brightness values in any one band of an image of 1 bite (brightness value range: 0 to 255)×3 bands (RGB). Under each discretization width, N_{off} kinds of different offset values are applied, and the brightness values of the image are discretized. For example, in the case of “discretization width for brightness value=40” and “offset number=5”, the offset value width is 8, so that N_{off} kinds of discretized images corresponding to the respective offset values={0, 8, 16, 24, 32} are obtained. Under the offset value=0, an identical discretization value is assigned to brightness values of “0 to 39” of an original image. Thus, brightness values are discretized into seven intervals including “40 to 79”, “80 to 119”, “120 to 159”, “160 to 199”, “200 to 239”, and “240 to 255”, as well as “0 to 39”. In the present experiment, the following parameters were used as an example.

Used band: Red (R) band

Discretization width Δd of brightness value={40, 30, 20}

Offset number N_{off}=5

Offset value width Δ_{off}=Δd/N_{off}={8, 6, 4}

(Second Step)

Next, in each discretized image, searching is performed in four directions (up, down, right, left) and pixels having the same value are linked and extracted as a region. A large region equal to or larger than a certain area (for example, 6400 pixels or more) is eliminated. In addition, with regard to a small region smaller than a certain area (for example, less than 80 pixels), if a region equal to or larger than a certain area is present at the periphery thereof, they are merged, and if no such region is present, said small region is eliminated. Thereafter, an edge (boundary) of each region is extracted.

(Third Step)

Next, the edges obtained from the N_{off} kinds of discretized images for one discretization width are overlapped into one image.

(Fourth Step)

Next, edges having an intensity equal to or greater than a certain intensity are left, and edges to be linked with such edges are also extracted. At this time, in the case where adjacent roofs or buildings have almost the same brightness value, their edges are often not extracted. Therefore, even at a portion having no edge, if presence of a linear edge is recognized at the periphery thereof, the edges are linked with each other.

Supplementary explanation of this edge linking will be provided. First, searching is performed in eight directions (up-down, right-left, diagonal) around a pixel that is not an edge, to find out the number of edges present within a certain number (d) of pixels.

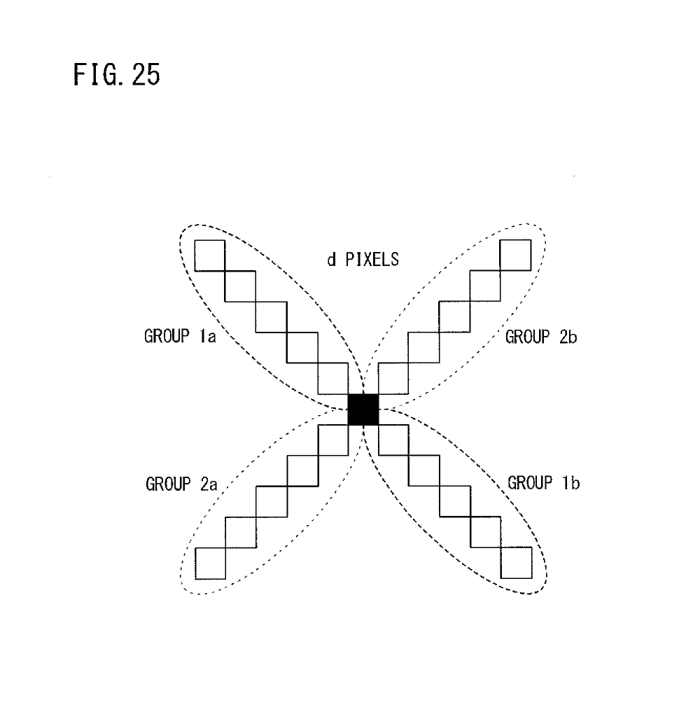

FIG. 25 shows an example of searching in an edge group 1a present in the upper left direction and an edge group 1b present in the lower right direction. For example, a condition (a) that the group 1a contains d1 or more edges and the group 1b also contains d1 or more edges, and a condition (b) that the group 2a contains d2 or less edges and the group 2b also contains d2 or less edges, are prepared. Then, if the conditions (a) and (b) are both satisfied, an edge is interpolated at the center pixel which is a non edge. The condition (b) prevents a pixel inside a rectangular region, that is near a corner of the rectangular region, from being erroneously extracted as an edge. The searching is performed four times, i.e., in the up-down direction, the right-left direction, the upper-left to lower-right direction, and then the upper-right to lower-left direction. Here, d=7, d1=5, and d2=1 were set.

(Fifth Step)

Next, label numbers are assigned (labeling) to regions closed by edges, and a region appearing to be a vegetation region is eliminated judging from the RGB brightness values. As in the second step, a large region equal to or larger than a certain area (for example, 6400 pixels or more) is eliminated. In addition, with regard to a small region equal to or smaller than a certain area (for example, 30 pixels or less), if a region equal to or larger than a certain area is present at the periphery thereof, they are merged, and if no such region is present, said small region is eliminated.

Supplementary explanation of the vegetation elimination will be provided. In the target area, green-based vegetation and red-based vegetation were recognized. Therefore, an occupation rate R_{grn}_{_{—}}_{veg} or R_{red}_{_{—}}_{veg} of pixels that satisfy the following condition (1) or (2).

B_{grn}≧T_{veg,DN},B_{blue}≧T_{veg,DN}, and B_{grn}/B_{blue}≧T_{veg,g2b}_{_{—}}ᵣₐₜᵢₒ (1)

B_{red}≧T_{veg,DN},B_{blue}≧T_{veg,DN}, and B_{red}/B_{blue}≧T_{veg,r2b}_{_{—}}ᵣₐₜᵢₒ (2)

Here, B_{red}, B_{grn}, and B_{blue} are brightness values of red, green, and blue bands. T_{veg, DN} is a threshold value for brightness value. T_{veg, g2b}_{_{—}}ᵣₐₜᵢₒ and T_{veg, r2b}_{_{—}}ᵣₐₜᵢₒ are threshold values for index. If R_{grn}_{_{—}}_{veg} or R_{red}_{_{—}}_{veg} is equal to or greater than the threshold value T_{veg, ratio}, such a region is eliminated as a vegetation region. Here, T_{veg, DN}=20, T_{veg, g2b}_{_{—}}ᵣₐₜᵢₒ=1.25, T_{veg, r2b}_{_{—}}ᵣₐₜᵢₒ=2.0, and T_{veg, ratio}=0.3 were employed.

(Sixth Step)

Next, an index referred to as a rectangle index of each region is calculated as follows.

(i) A first axis and a second axis are determined from 2-dimensional coordinates of a collection (referred to as an edge set) of edges of a region.

(ii) The presence range of each region is represented by values on the first axis and the second axis, and (maximum value−minimum value+1) on the first axis is multiplied by (maximum value−minimum value+1) on the second axis, to obtain the area of a rectangle surrounding the region.

(iii) A value, “actual area of a region/area of a rectangle surrounding the region”, is defined as a rectangle index.

Here, if a rectangle index is smaller than a certain value (for example, 0.4), it is considered that there is a high possibility that the corresponding region is not a building, and therefore said region is excluded from extraction targets.

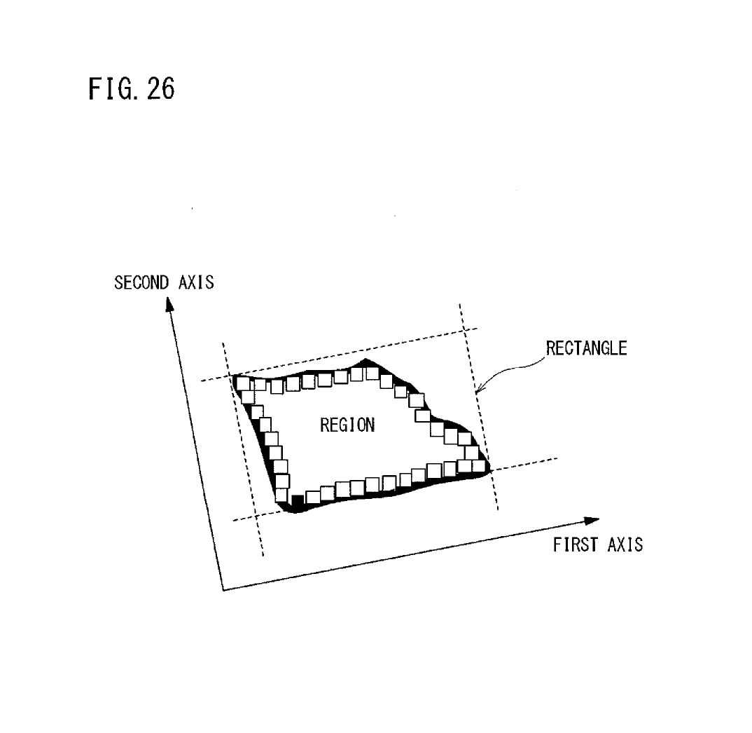

Supplementary explanation of the rectangle index will be provided. FIG. 26 shows a conceptual diagram of rectangle index calculation. A first axis and a second axis are calculated from an edge set of one region. Then, the smallest one of rectangles having respective sides parallel to the first and second axes and surrounding the target region, as shown in FIG. 26, is calculated. For determination of the first and second axes, voting of the slope of line is performed by using each edge set in which the distance between two points is within a certain range (from 5 pixels to 20 pixels), and then a slope of line that appears most frequently is defined as the direction of the first axis, and the second axis is defined to be perpendicular to the first axis. The rectangle index is defined by the following expression.

i_{dx}=S_{actual}/S_{rect} (1)

Here, i_{dx} is the rectangle index, S_{actual} is the area of a region, and S_{rect} is the area of a rectangle surrounding the area. The rectangle index takes a value in a range from 0 to 1. The closer to 1 the rectangle index is, the closer to a rectangle the shape of the region is. Owing to such an index, the degree of “closeness” of a shape close to a rectangle can be simply and properly represented as an index.

(Seventh Step)

In the seventh step, by using the rectangle index shown by expression (1), roofs or buildings divided by a shadow are merged to estimate an original region.

For example, regions in the neighborhood of one region A are searched for to determine whether or not each region satisfies the following conditions.

(i) A rectangle index when merged with the region A becomes greater than a rectangle index of each single region.

(ii) The rectangle index is equal to or greater than a designated threshold value (0.7).

(iii) The difference between the average brightness values of both regions is equal to or smaller than a certain value (30).

Among neighborhood regions satisfying these conditions, a region having the greatest rectangle index when merged is set as a candidate, which is provisionally defined as a region B. Also for the region B, searching is performed in the same manner, and then if the region A satisfies all the conditions (i) to (iii) and the rectangle index when they are merged is the greatest, the regions A and B are merged with each other.

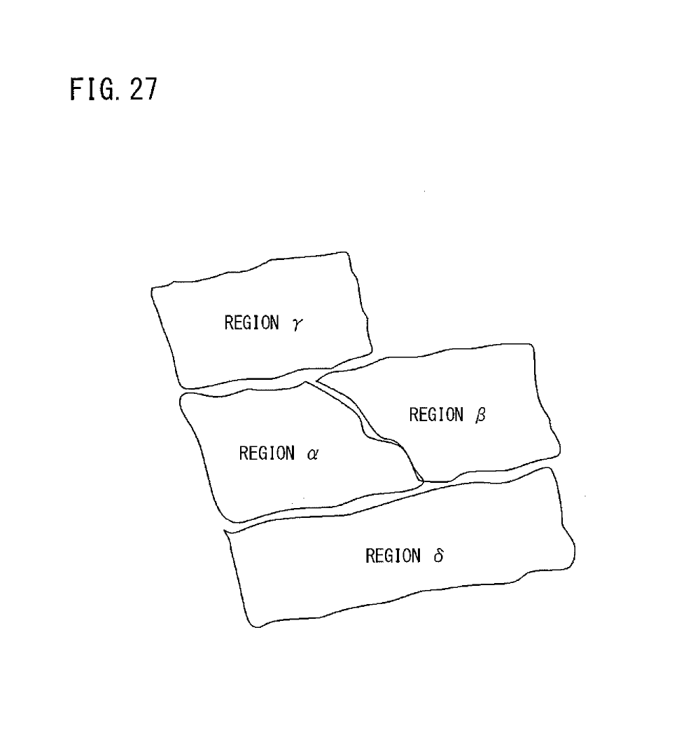

For example, as shown in FIG. 27, for each of regions β, γ, and δ adjacent to a target region α, a rectangle index in the case where they are merged is calculated. At this time, among edge sets of the two regions, edge sets excluding an edge set close to each other's region are used to perform calculation of the first and second axes. For determination of the axes, voting of the slope of line is performed by using each edge set in which the distance between two points is within a certain range (from 5 pixels to 20 pixels), and then a slope of line that appears most frequently is defined the direction of as the first axis, and the second axis is defined to be perpendicular to the first axis.

(Eighth Step)

Next, regions equal to or larger than a certain area, obtained under the N_{disc} kinds of discretization widths, are selected in decreasing order of rectangle index. It is noted that if even a part of such a region overlaps with a region that has been already selected, said region is not selected.

(Ninth Step)

Selection is performed again for regions that have not been selected. At this time, if a part overlapping with a region that has been already selected is smaller than a certain rate (30%) and smaller than a certain area (80 pixels), only the left part that does not overlap is additionally selected as a new region. It is noted that a rectangle index is calculated also for the part that does not overlap, and the part is selected only in the case where the rectangle index is equal to or greater than a threshold value (0.45).

(Tenth Step)

Finally, a hollow part inside each region is filled.

### Examples

Hereinafter, examples will be shown. FIG. 28 shows a result of edge extraction for an urban area (hereinafter, referred to as an area 1) where low-rise buildings are densely located. In FIG. 28, (a) is an aerial photograph of an area with an actual size of about 75 m×75 m taken with a photograph resolution of 300×300 pixels. (b) shows a result of application of a known Canny filter to the data shown in (a). (c) shows an edge extraction result (first phase) in the case of using a discretization width 40 in the above-described discretization. (d) shows an edge extraction result (second phase) in the case of using a discretization width 30. (e) shows an edge extraction result (third phase) in the case of using a discretization width 20.

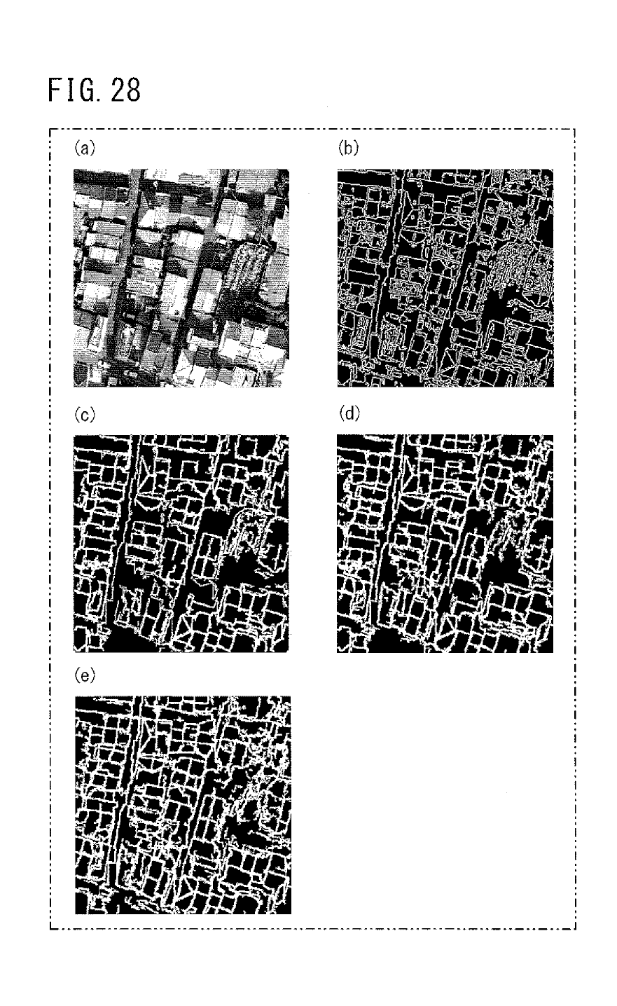

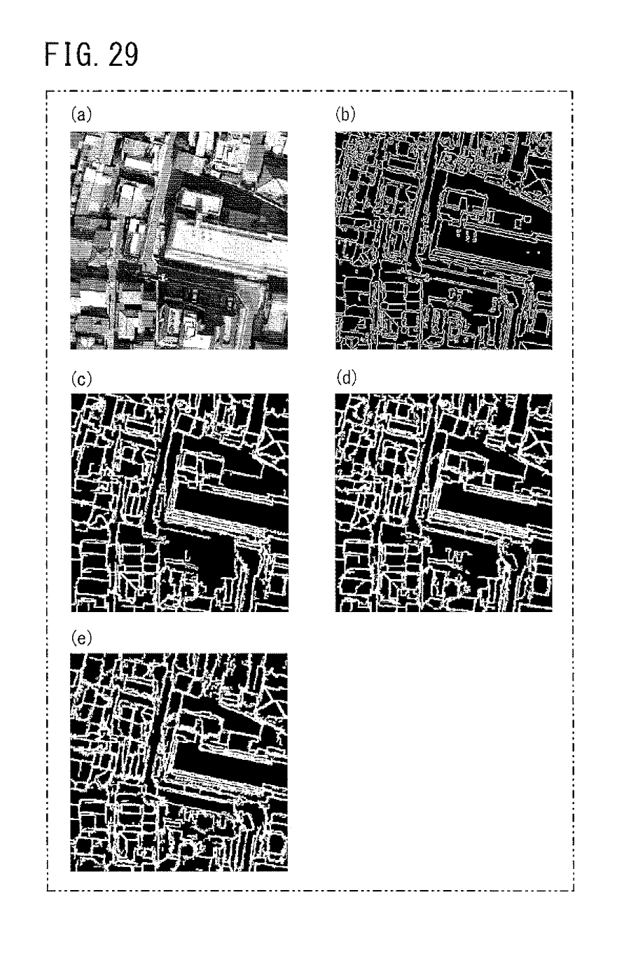

FIG. 29 shows a result of edge extraction for an urban area (hereinafter, referred to as an area 2) including high-rise buildings and low-rise buildings in a mixed manner. Similarly to FIG. 28, (a) is an aerial photograph, (b) shows a result of application of a Canny filter, (c) shows an edge extraction result (first phase) in the case of using a discretization width 40, (d) shows an edge extraction result (second phase) in the case of using a discretization width 30, and (e) shows an edge extraction result (third phase) in the case of using a discretization width 20.

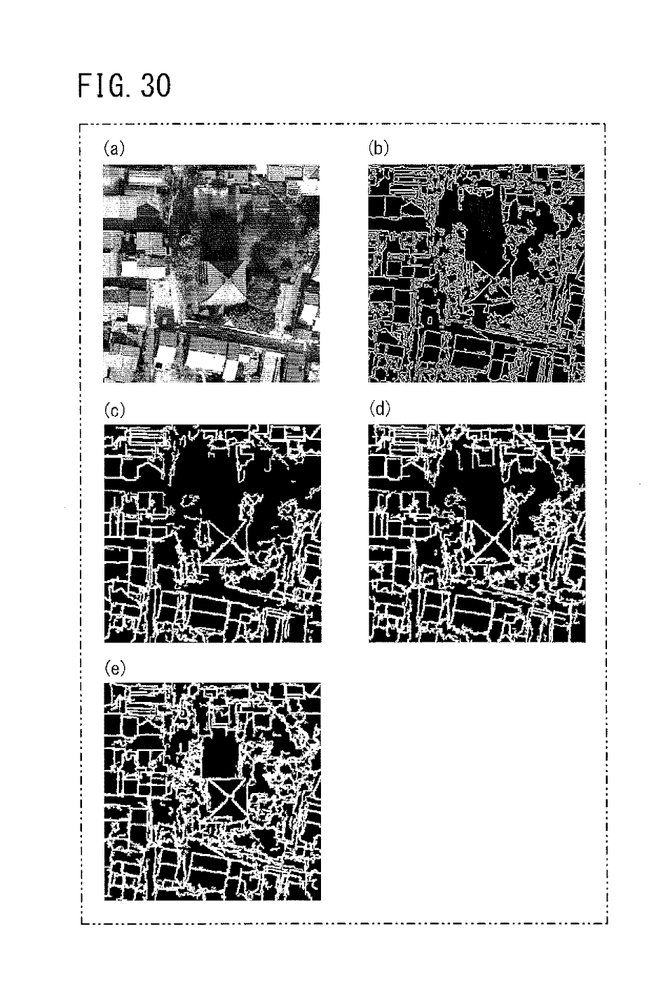

FIG. 30 shows a result of edge extraction for an area (hereinafter, referred to as an area 3) including a tall tree adjacent to a building. Similarly to FIG. 28, (a) is an aerial photograph, (b) shows a result of application of a Canny filter, (c) shows an edge extraction result (first phase) in the case of using a discretization width 40, (d) shows an edge extraction result (second phase) in the case of using a discretization width 30, and (e) shows an edge extraction result (third phase) in the case of using a discretization width 20.

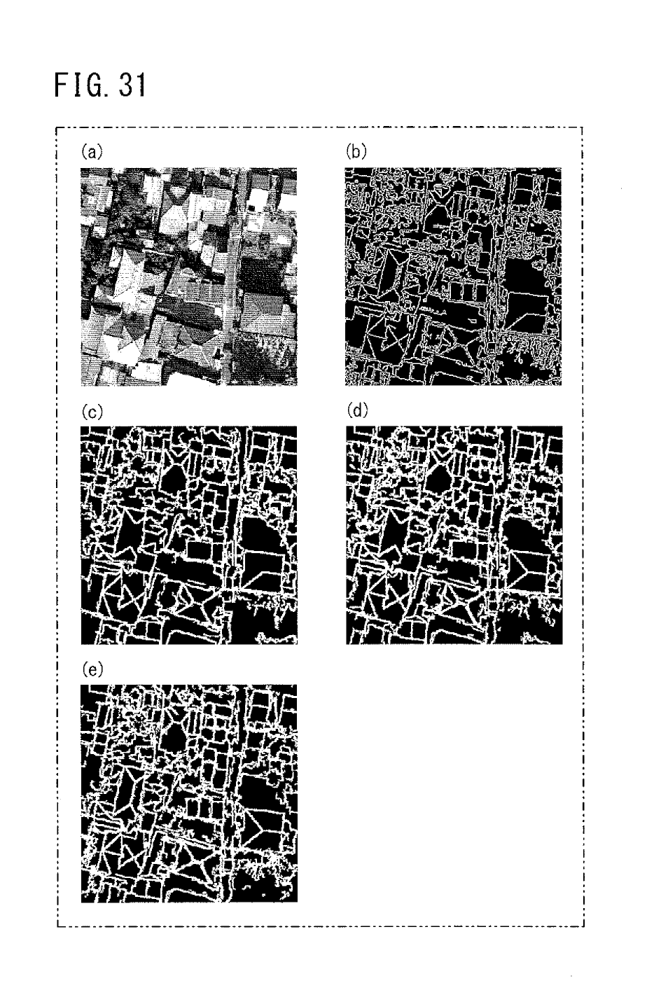

FIG. 31 shows a result of edge extraction for an area (hereinafter, referred to as an area 4) including many hip roof buildings. Similarly to FIG. 28, (a) is an aerial photograph, (b) shows a result of application of a Canny filter, (c) shows an edge extraction result (first phase) in the case of using a discretization width 40, (d) shows an edge extraction result (second phase) in the case of using a discretization width 30, and (e) shows an edge extraction result (third phase) in the case of using a discretization width 20.

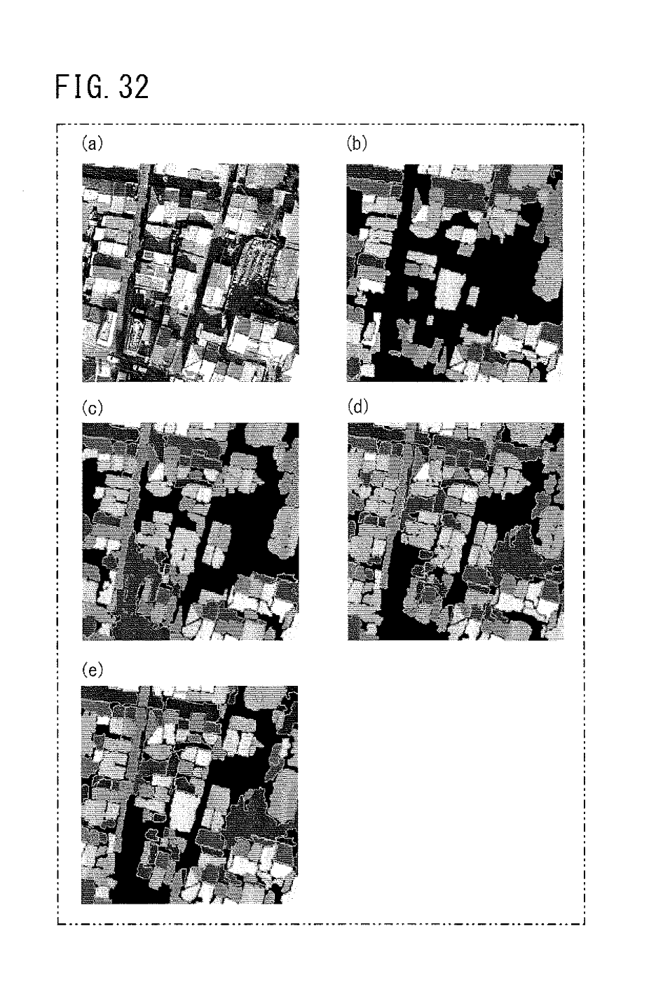

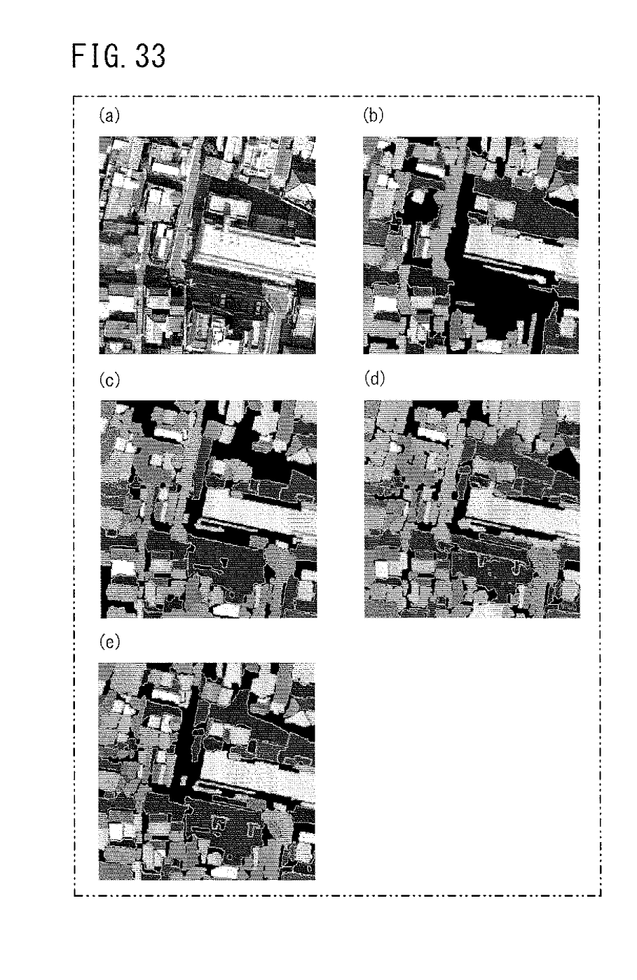

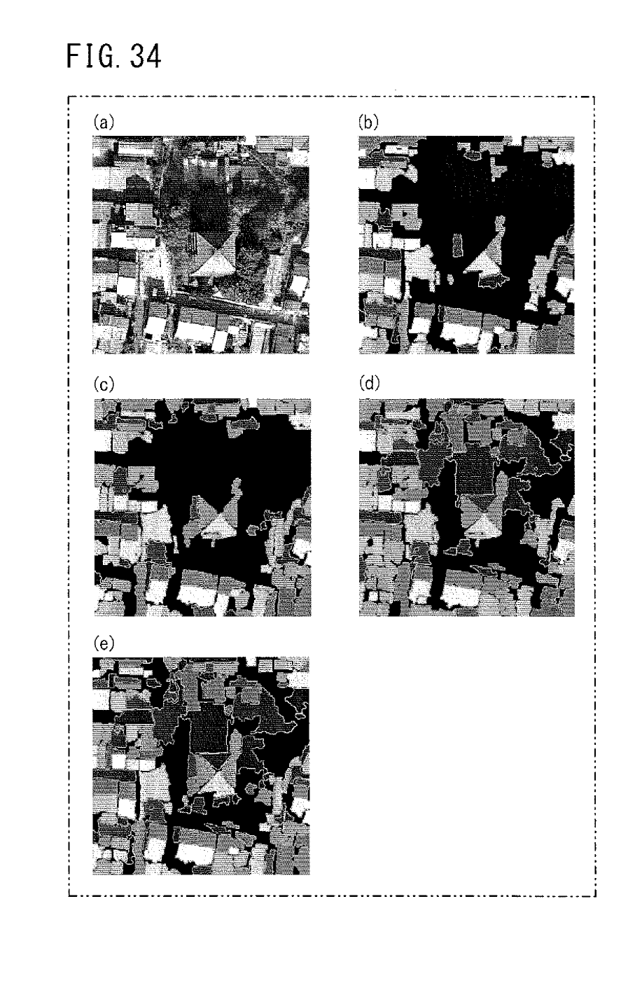

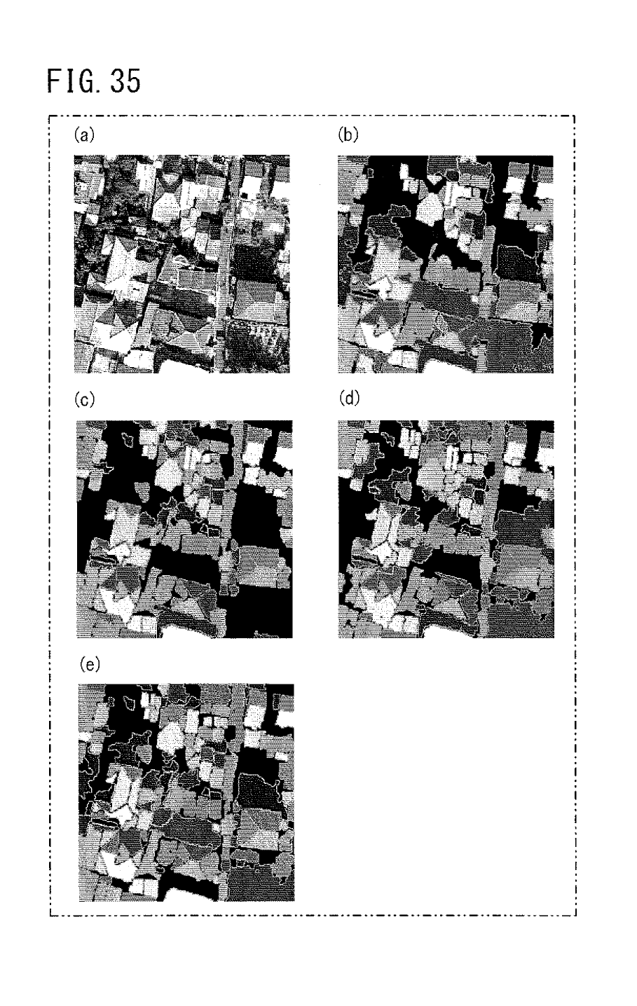

FIG. 32, FIG. 33, FIG. 34, and FIG. 35 respectively show results of region extraction for the area 1 (FIG. 7), the area 2 (FIG. 29), the area 3 (FIG. 30), and the area 4 (FIG. 31) described above. In each of FIGS. 32 to 35, (a) is an aerial photograph of each area, (b) shows a region extraction result (first phase) in the case of using the discretization width 40, (c) shows a region extraction result (second phase) in the case of using the discretization width 30, (d) shows an edge extraction result (third phase) in the case of using the discretization width 20, and (e) shows a final result obtained when the three results ((b) to (d)) are merged by using a rectangle index. In any of FIGS. 32 to 35, as is obvious from comparison between the result (e) and the results (b) to (d), (e) shows the state including the best local portions of each of the three results, in which the regions (edges) of buildings are extracted more accurately.

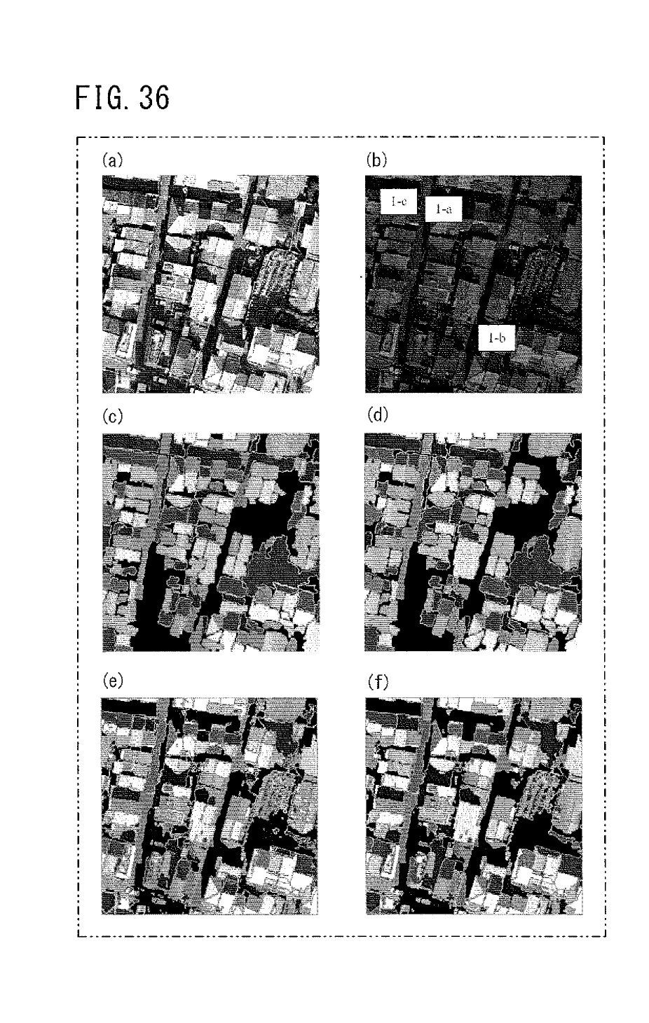

FIG. 36 shows drawings about the area 1. Specifically, (a) is an aerial photograph, (b) shows reference points for comparison of region extraction results, (c) shows a region extraction result (in the case of using principal component analysis for calculating a principal direction), (d) shows a region extraction result (in the case of performing voting of the slope of line passing through two points for calculating the principal direction), (e) shows a region extraction result by image processing software, ENVI EX, of ITT Visual Information Solutions in the case of setting Scale=50 and Merge=50, and (f) shows a region extraction result by ENVI EX in the case of setting Scale=50 and Merge=80. It is noted that in (c) to (f), although the edges of buildings are clearly displayed in the case of color image, here, a portion appearing to border each building is an edge.

It is noted that parameters required to be set in a function called “Feature Extraction” of ENVI EX are “Scale Level” and “Merge Level”. The target area in the present example includes roofs having textures with great dispersion values. Since the sizes and the number of regions that will be finally left vary by changing the “Merge Level”, “Scale Level=50.0” is commonly used while two kinds of values, “Merge Level=50.0” and “Merge Level=80.0”, are used to execute the processing.

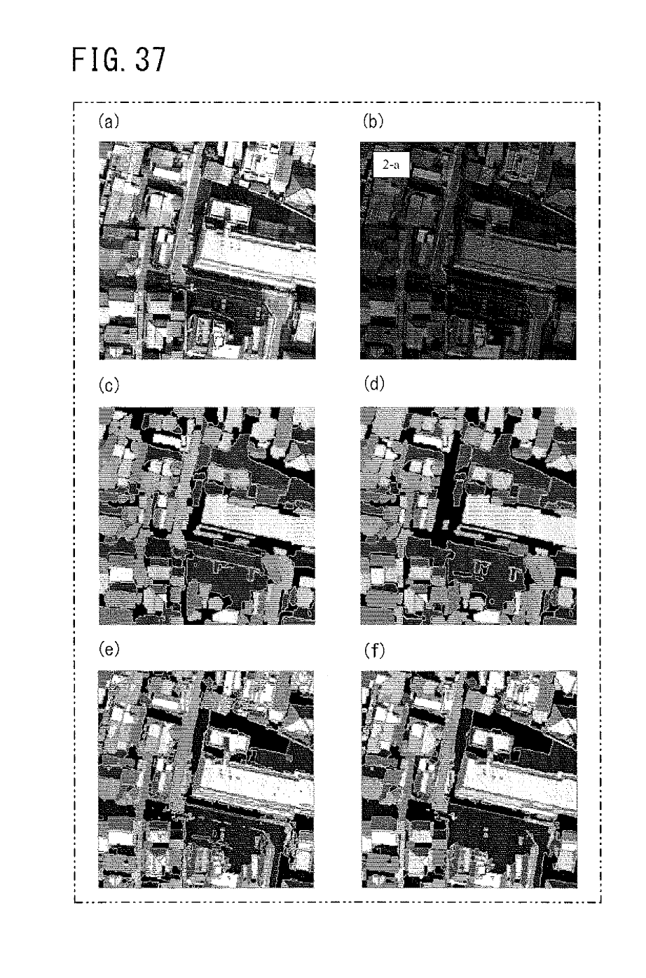

FIG. 37 shows drawings about the area 2. Specifically, (a) is an aerial photograph, (b) shows a reference point for comparison of region extraction results, (c) shows a region extraction result (in the case of using principal component analysis for calculating a principal direction), (d) shows a region extraction result (in the case of performing voting of the slope of line passing through two points for calculating the principal direction), (e) shows a region extraction result by ENVI EX in the case of setting Scale=50 and Merge=50, and (f) shows a region extraction result by ENVI EX in the case of setting Scale=50 and Merge=80.

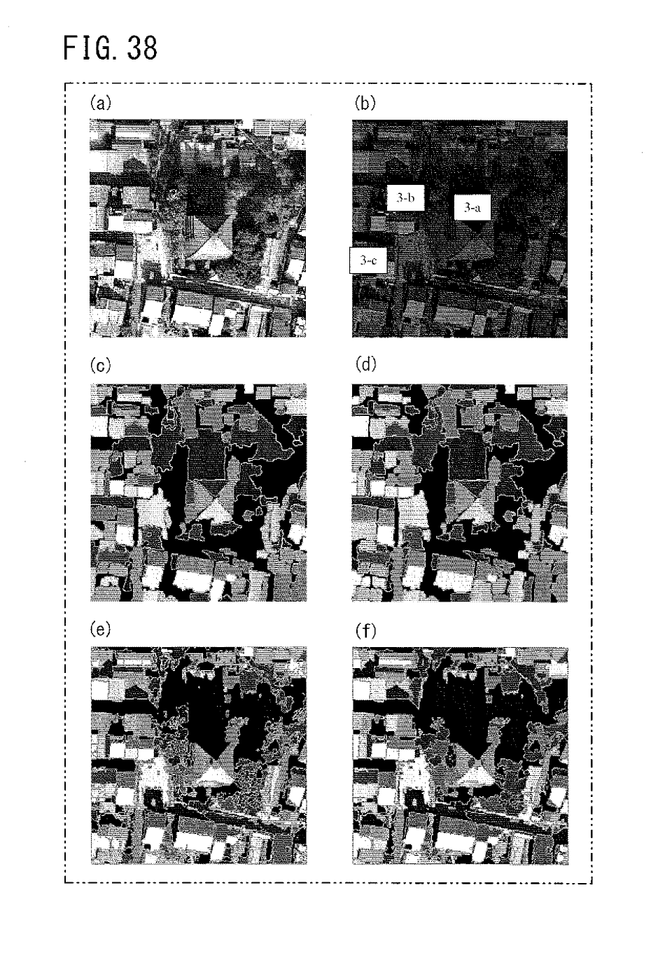

FIG. 38 shows drawings about the area 3. Specifically, (a) is an aerial photograph, (b) shows reference points for comparison of region extraction results, (c) shows a region extraction result (in the case of using principal component analysis for calculating a principal direction), (d) shows a region extraction result (in the case of performing voting of the slope of line passing through two points for calculating the principal direction), (e) shows a region extraction result by ENVI EX in the case of setting Scale=50 and Merge=50, and (f) shows a region extraction result by ENVI EX in the case of setting Scale=50 and Merge=80.

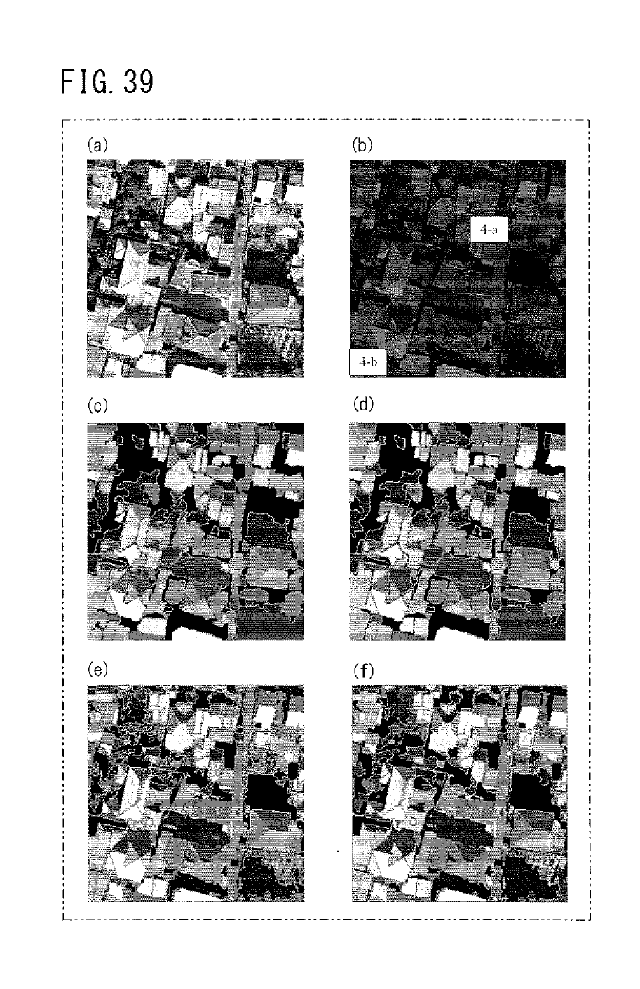

FIG. 39 shows drawings about the area 4. Specifically, (a) is an aerial photograph, (b) shows reference points for comparison of region extraction results, (c) shows a region extraction result (in the case of using principal component analysis for calculating a principal direction), (d) shows a region extraction result (in the case of performing voting of the slope of line passing through two points for calculating the principal direction), (e) shows a region extraction result by ENVI EX in the case of setting Scale=50 and Merge=50, and (f) shows a region extraction result by ENVI EX in the case of setting Scale=50 and Merge=80.

In each of FIG. 36 to FIG. 39, as is obvious from comparison between the results (c) and (d) on the middle stage and the results (e) and (f) on the lower stage, rectangular regions of buildings have been extracted more accurately in the results (c) and (d) of the region extractions of the present embodiment. In the results (e) and (f) by ENVI EX, there are so many unnecessary edges and so many excessively fine edges, and thus the perfection levels are low as compared to the results (c) and (d).

<<Consideration>>

In the region extraction methods according to the above embodiment, edges obtained by applying different discretization widths are merged. This is essentially equal to performing processing using conversion into different spatial resolutions. However, since the merging is performed while the offset value is sequentially changed and applied, edges are preserved unlike the case of merely using a smoothing filter. What is most important is that sequentially employing regions in decreasing order of rectangle index among a region set obtained by applying a plurality of different discretization widths is equal to applying a spatial smoothing parameter that is locally optimum.

From FIG. 32 to FIG. 35, it is shown that a spatial scale parameter that is locally optimum could be selected in accordance with the sizes of roofs and buildings through the merging processing. However, it takes a time to perform labeling using a discretized image, and the processing time increases with increase in the image size. For example, in the case of a computer using a CPU operating with a clock of 3.2 GHz and a memory of 6 GB, the average processing time for each target area was about 90 seconds.

It is preferable to utilize an index about shape calculated from edges of a region, thereby preferentially extracting regions having a rectangular shape which can be seen on a roof or a building. At this time, there are many roofs and buildings that are not fully closed even after their edges are extracted, which is a factor of deterioration in the accuracy of the region extraction. Therefore, it is preferable to, for such an edge set that is not fully closed, add processing of closing the edges in the case where there is a high possibility of becoming a rectangular shape or a triangular shape.

In addition, particularly from the result in the case of Δd=20 ((e) of FIGS. 28 to 31), it is found that edges of roofs with shadows as shown by the reference points 1-a, 1-b, 3-a, and 4-a in FIGS. 36 to 39 could be clearly extracted by using, for example, the three different discretization widths described above. Also in these cases, it was confirmed that division is not achieved without the processing of closing edges, and thus the effectiveness of the edge interpolation (linking) processing was confirmed. That is, it is considered that two factors of the edge interpolation processing and merging of results of using different discretization widths exerted an effect to improve the region extraction accuracy. It is noted that it was confirmed that without the condition that “a difference between the average brightness values of regions is equal to or smaller than a certain value” shown in step 7, even clearly divided roofs were excessively merged.

From the results shown in FIGS. 36 to 39, it is found that triangular regions which are seen on a hip roof were preferably extracted. The rectangle index of an ideal triangle is 0.5 at most, so such triangular regions are not preferentially employed. One of factors of the preferable extraction at this time is that a rectangular region at the periphery of a triangular region was preferably extracted. Depending on the discretization width or the offset value, a triangular region and a rectangular region may be merged. However, in the case where region extraction results obtained by three kinds of discretization widths are evaluated by a scale of rectangle index, the rectangle index of a region obtained by merging a triangular region and a rectangular region is lower than the rectangle index of the original single rectangular region, and therefore, such a region is less likely to be employed. Based on such a selection process, rectangular regions were selected first, and then triangular regions were extracted.

In the result of the above method, a range in which there is no region is wider as compared to a result of a known region extraction method. This may be partially attributable to provision of the upper limit for a region area, but is greatly attributable to processing of eliminating regions having a rectangle index smaller than a certain value (0.4) by considering that such regions are less likely to be roofs or buildings. The shapes of most of vegetation regions, if not all, and a region containing graves shown in FIG. 36 are far from a rectangle, and consequently they could be eliminated. That is, it can be said that a function as building region extraction was sufficiently exerted.

The rectangle index will be described in terms of region area. In the present method, since regions are sequentially extracted in decreasing order of rectangle index, comparatively small regions are often preferentially extracted while regions having a small rectangle index but roughly having an outer shape as a rectangle may not be selected. Then, a method for adapting to the case where such a region roughly having a shape as a rectangle is desired to be recognized was considered. For example, by executing correction using the following expression (2), some regions were obtained each of which is larger than in the results shown in FIGS. 36 to 39 and corresponds to a plurality of roofs and buildings.

Δi_{dx}=C₁·ln(S_{actual}·C₂+C₃) (2)

Here, Δi_{dx} is a correction value for rectangle index, and C₁ to C₃ are coefficients that are experientially set. As a result of experiential confirmation obtained by application to the above target areas, C₁=0.05, C₂=100.0, and C₃=1.0 were employed. It was found out that among the coefficients in expression (2), particularly, C₁ has a significant influence on a final extraction result. If C₁=1.0 is set, the correction value became excessively large, so that the rectangle index of a road and the rectangle index of a region linked thereto and having a large area increased and accordingly such regions were preferentially selected. As a result, the extraction number of originally intended roofs and buildings decreased. Although areas including Japanese traditional buildings were targeted at this time, the function and parameter values in the rectangle index correction should be adjusted taking buildings to be extracted into consideration.

On the other hand, regarding the calculation of rectangular index, in (c) of FIGS. 36 to 39, results of region extraction in the case where the axes are determined by principal component analysis, are shown. At the reference points 2-a, 3-b, 3-c, and 4-b, in the case of applying principal component analysis, a region of a slate roof is divided and thus extracted in a partially lacked state. In the case of applying principal component analysis to a region by using its edge set, unless the region is a perfect rectangle, particularly, for a roof divided by a shadow as targeted at this time, a result was obtained that the first principal component was not always parallel to a side of the roof. Meanwhile, at the reference point 1-c, in a region extraction result in the case of using principal component analysis, four roofs were extracted as one large region.

Thus, it was confirmed that stability of a region extraction result was lost in the case of using principal component analysis. Therefore, instead of applying principal component analysis, voting of the slopes of lines was performed by using each edge set in which the distance between two points was within a certain range, and then a slope that appeared most frequently was defined as the direction of the first axis, and the second axis was defined to be perpendicular to the first axis. By changing the upper limit or the lower limit of the distance between two points, some region extraction results were also changed, but the changes were not so large as in the case of using principal component analysis. These threshold values are required to be experientially determined in accordance with the characteristics of a target area.

Finally, elimination of a vegetation region will be described. In the present embodiment, building extraction for an urban area is intended and vegetation is a target to be eliminated. As preprocessing for region extraction, a method of eliminating a pixel having a high vegetation likelihood by referring to the brightness value on a pixel by pixel basis is also conceivable. However, since vegetation partially overlapping with a roof or a road is eliminated, the original shape of the roof or the building may not be obtained or divided, or the region may become excessively small so that the region may not be extracted.

As a result of consideration, it was decided that the processing should be executed such that vegetation regions would be included as a target of region extraction, and then the elimination should be applied at the final phase. It can be said that this policy actually contributed to highly accurate extraction. For example, upon elimination of red vegetation, a red roof was sometimes erroneously eliminated. Therefore, in order to carefully eliminate red vegetation, the threshold value was set to be rather high, i.e., at T_{veg, r2b}_{_{—}}ᵣₐₜᵢₒ=2.0. By a similar concept, a shadow was extracted as one region, and then the region was merged with a neighborhood region if the resultant rectangle index increased. Regions appearing to be a shadow included many roads, and therefore elimination of such regions by using brightness values was also considered. However, it was confirmed that some roofs or buildings were erroneously eliminated. Therefore, such elimination was not employed eventually.

As described above, according to the region extraction of the present embodiment, buildings or roofs in a dense urban area can be effectively extracted as a region. In this method, in order to effectively extract also a roof having a texture with great dispersion of brightness value, the brightness values are discretized into a small number of values, and each region having an identical discretized value is labeled. Then, by utilizing a rectangle index calculated from edges of a region, regions having a rectangular shape which can be seen on roofs and buildings are preferentially extracted. In addition, for such an edge set that is not fully closed, processing of closing the edges in the case where there is a high possibility of becoming a rectangular shape or a triangular shape is added.

In the experiment using an aerial photograph with 25 cm resolution of an area where traditional buildings are densely located in Kyoto City, three different discretization widths were applied. Then, two factors of the edge interpolation processing and merging of results of using different discretization widths exerted an effect that a shadow region can be also clearly extracted, which cannot be sufficiently extracted by a known method. The most important feature of the present method is that in a region set obtained by applying a plurality of different discretization widths, regions are sequentially employed in decreasing order of rectangle index, thereby realizing processing equal to application of a spatial smoothing parameter that is locally optimum.

A triangular region which can be seen on a hip roof has a low rectangle index and is not preferentially employed, but consequently could be preferably extracted. The rectangle index of a region obtained by merging a triangular region and a rectangular region is lower than the rectangle index of the original single rectangular region, and therefore, such a region is less likely to be employed. Therefore, rectangular regions were selected first, and then triangular regions were extracted. Eventually, for all target areas of an urban area where low-rise buildings are densely located, an urban area in which high-rise buildings and low-rise buildings are located in a mixed manner, an area including a tall tree adjacent to a building, and an area including many hip roof buildings, more preferable results could be obtained than in a conventional region extraction method. Thus, it was confirmed that the method having features on discretization of brightness value and utilization of rectangle index is useful.

In the above embodiment, aerial photographs have been used as original data. However, instead of aerial photographs, data of photographs taken with a high accuracy from a satellite can be also used.

It is noted that the embodiment disclosed herein is merely illustrative in all aspects and should not be recognized as being restrictive. The scope of the present invention is defined by the scope of the claims, and is intended to include meaning equivalent to the scope of the claims and all modifications within the scope.

### REFERENCE SIGNS LIST

[DTM estimation method, DTM estimation program, DTM estimation device, and method for creating 3-dimensional building model]
1a river extraction section
1b DTM estimation section
7 drive (input device)
8 display (display section)

[Region extraction method, region extraction program, and region extraction device]
10 computer device (region extraction device)

1. A DTM estimation method for, based on laser scanner data of an earth's surface obtained by an aircraft, estimating a DTM which is elevation data of only a ground surface for a predetermined range of the laser scanner data, by using a computer, the DTM estimation method comprising:
linking pixels where no data is present within a unit grid in the predetermined range, to extract a river region;
setting a first maximum allowable slope value and provisionally estimating a DTM for data excluding the river region;
calculating a local slope from the estimated DTM; and
if the slope exceeds a predetermined value, setting a second maximum allowable slope value greater than the first maximum allowable slope value and estimating a DTM again.

2. The DTM estimation method according to claim 1, wherein the second maximum allowable slope value is increased or decreased in accordance with features of a terrain and an urban landscape.

3. A method for creating 3-dimensional building model including the DTM estimation method according to claim 1, the method for creating 3-dimensional building model comprising:
dividing the laser scanner data into a DTM estimated by the DTM estimation method and non-ground surface data; and
determining, for each of regions in the non-ground surface data, whether or not normal vectors having directions to be paired are present, and estimating a shape of a roof based on a result of the determination.

4. The method for creating 3-dimensional building model according to claim 3, wherein the regions are extracted in advance by preferentially extracting at least rectangular shapes from data of an aerial photograph in the predetermined range.

5. A DTM estimation program for, based on laser scanner data of an earth's surface obtained by an aircraft, estimating a DTM which is elevation data of only a ground surface for a predetermined range of the laser scanner data, the DTM estimation program causing a computer to realize:
a function of linking pixels where no data is present within a unit grid in the predetermined range, to extract a river region;
a function of setting a first maximum allowable slope value and provisionally estimating a DTM for data excluding the river region;
a function of calculating a local slope from the estimated DTM; and
a function of, if the slope exceeds a predetermined value, setting a second maximum allowable slope value greater than the first maximum allowable slope value and estimating a DTM again.

6. A DTM estimation device for, based on laser scanner data of an earth's surface obtained by an aircraft, estimating a DTM which is elevation data of only a ground surface for a predetermined range of the laser scanner data, the DTM estimation device comprising:
an input device for reading laser scanner data of an earth's surface obtained by an aircraft;
a river extraction section for linking pixels where no data is present within a unit grid in the predetermined range of the laser scanner data, to extract a river region;
a DTM estimation section for setting a first maximum allowable slope value and provisionally estimating a DTM for data excluding the river region, calculating a local slope from the estimated DTM, and if the slope exceeds a predetermined value, setting a second maximum allowable slope value greater than the first maximum allowable slope value and estimating a DTM again; and
a display section for displaying the estimated DTM.

7. A region extraction method for, based on data of a photograph taken from an aircraft or a satellite, extracting a region of a building by using a computer, the region extraction method comprising:
setting a plurality of different discretization widths and discretizing brightness values of the data into a plurality of values discretely set by using each of the discretization widths;
linking pixels having an identical value in a discretized image obtained by the discretization, and extracting a region having a shape close to a rectangle as a candidate of a region of a building; and
employing, as a region of a building, a region among a plurality of region sets extracted for the respective plurality of different discretization widths, in decreasing order of closeness of shape to a rectangle.

8. The region extraction method according to claim 7, wherein a rectangle index defined by (area of a region/area of rectangle surrounding the region) is used as an index representing closeness of shape to a rectangle.

9. The region extraction method according to claim 7, wherein in the extraction, if a shape of a region obtained by merging regions adjacent to each other becomes further close to a rectangle, the merging can be performed.

10. The region extraction method according to claim 8, wherein if the rectangle index is smaller than a predetermined value, the corresponding region is not employed as a region of a building.

11. The region extraction method according to claim 7, wherein a region estimated as vegetation based on RGB brightness values thereof is excluded from a target of the extraction.

12. A region extraction program for, based on data of a photograph taken from an aircraft or a satellite, extracting a region of a building, the region extraction program causing a computer to realize:
a function of setting a plurality of different discretization widths and discretizing brightness values of the data into a plurality of values discretely set by using each of the discretization widths;
a function of linking pixels having an identical value in a discretized image obtained by the discretization, and extracting a region having a shape close to a rectangle as a candidate of a region of a building; and
a function of employing, as a region of a building, a region among a plurality of region sets extracted for the respective plurality of different discretization widths, in decreasing order of closeness of shape to a rectangle.

13. A region extraction device for, based on data of a photograph taken from an aircraft or a satellite, extracting a region of a building, the region extraction device comprising:
a function of setting a plurality of different discretization widths and discretizing brightness values of the data into a plurality of values discretely set by using each of the discretization widths;
a function of linking pixels having an identical value in a discretized image obtained by the discretization, and extracting a region having a shape close to a rectangle as a candidate of a region of a building; and
a function of employing, as a region of a building, a region among a plurality of region sets extracted for the respective plurality of different discretization widths, in decreasing order of closeness of shape to a rectangle.

14. The region extraction method according to claim 8, wherein in the extraction, if a shape of a region obtained by merging regions adjacent to each other becomes further close to a rectangle, the merging can be performed.
